(19) United States
(12) Patent Application Publication
(10) Pub. No.: US 2026/0049371 A1
(43) Pub. Date: Feb. 19, 2026

(54) Steel having improved processing properties for working at elevated temperatures

(71) Applicant: THYSSENKRUPP STEEL EUROPE AG, Duisburg (DE)

(72) Inventors: Jonas SCHWABE, Duisburg (DE); Cássia CASTRO MÜLLER, Oberhausen (DE); Thomas GERBER, Dortmund (DE); Dirk ROSENSTOCK, Essen (DE); Sebastian STILLE, Dortmund (DE); Tobias SCHAFFNER, Rheinberg (DE)

(21) Appl. No.: 19/101,115

(22) PCT Filed: Aug. 15, 2023
(86) PCT No.: PCT/EP2023/072431

§ 371 Date: Feb. 4, 2025

(30) Foreign Application Priority Data
Aug. 18, 2022 (EP) 22190910.4

(51) Int. Cl. C21D 9/00; B32B 15/01; C21D 6/00; C21D 8/02; C22C 21/02; C22C 38/00; C22C 38/02; C22C 38/04; C22C 38/06; C22C 38/42; C22C 38/44; C22C 38/46; C22C 38/48; C22C 38/50; C22C 38/54; C23C 2/02; C23C 2/12; C23C 2/28; C23C 2/40

(52) U.S. Cl. CPC C21D 9/0081; B32B 15/012; C21D 6/004; C21D 6/005; C21D 6/008; C21D 8/0205; C21D 8/0226; C21D 8/0236; C21D 8/0263; C21D 8/0278; C22C 21/02; C22C 38/001; C22C 38/002; C22C 38/005; C22C 38/008; C22C 38/02; C22C 38/04; C22C 38/06; C22C 38/42; C22C 38/44; C22C 38/46; C22C 38/48; C22C 38/50; C22C 38/54; C23C 2/0224; C23C 2/024; C23C 2/12; C23C 2/29; C23C 2/40

(57) ABSTRACT

A flat steel product for hot forming and to a shaped sheet metal part produced therefrom. The steel substrate of the flat steel product and of the shaped sheet metal part has elevated aluminum and vanadium contents. In a preferred variant, the steel substrate includes cerium and lanthanum.

The invention relates to a flat steel product for hot forming and to a process for producing such a flat steel product. The invention further relates to a shaped sheet metal part having improved properties and to a process for producing such a shaped sheet metal part from a flat steel product.

Where a “flat steel product” or else a “sheet metal product” is discussed hereinafter, this means rolled products such as steel strips or sheets, from which “sheet metal blanks” (also called blanks) are divided for the production of bodywork components, for example. “Shaped sheet metal parts” or “sheet metal components” of the type according to the invention have been produced from such sheet metal blanks; the terms “shaped sheet metal part” and “sheet metal component” are used synonymously here.

All figures relating to contents of the steel compositions that are reported in the present application are based on weight, unless explicitly stated otherwise. All indeterminate percentage figures associated with a steel alloy should therefore be regarded as figures in “% by weight”. With the exception of the statements relating to the residual austenite content of the structure of a shaped sheet metal part of the invention that are based on volume (reported in “% by volume”), figures relating to the contents of the various structure constituents are each based on the area of a section of a sample of the respective product (reported in area percent, “area %”), unless explicitly stated otherwise. Figures given in this text for the contents of the constituents of an atmosphere are based on volume (reported in “% by volume”).

Mechanical properties, such as tensile strength, yield point and elongation, that are reported here have been ascertained in the tensile test according to DIN-EN ISO 6982-1, sample form 2 (Annex B Tab. B1) (version of 2020-06), unless explicitly stated otherwise.

Bending angle is ascertained according to VDA standard 238-100 for the force maximum. In addition, bending angle is ascertained at a thickness of the shaped sheet metal part of 1.5 mm.

The structure was determined on longitudinal sections that had been subjected to etching with 3% Nital (alcoholic nitric acid). The proportion of residual austenite was determined by x-ray diffractometry.

WO 2019/223854 A1 discloses a shaped sheet metal part and a process for producing such a shaped sheet metal part that has a tensile strength of at least 1000 MPa. This shaped sheet metal part consists of a steel composed of, as well as iron and unavoidable impurities, (in % by weight) 0.10-0.30% C, 0.5-2.0% Si, 0.5-2.4% Mn, 0.01-0.2% Al, 0.005-1.5% Cr, 0.01-0.1% P and optionally further optional elements, especially 0.005-0.1% Nb. In addition, the shaped sheet metal part comprises an anticorrosion coating containing aluminum.

EP 3 483 299 A1 discloses a shaped sheet metal part and a process for producing such a shaped sheet metal part. This shaped sheet metal part consists of a steel consisting of, as well as iron and unavoidable impurities, (in % by weight) 0.27-0.40% C, 0.2-3.0% Mn, 0.11-0.4% V, 0-0.8% Si, 0-0.5% Al, 0-2% Cr, 0-0.15% Ti, 0-0.15% Nb, 0-0.004% B, and a total of less than 2% Mo, Ni and Cu.

WO 2020/239905 A1 discloses steel compositions having an elevated aluminum content of up to 0.130 for hot forming.

EP 2 553 133 B1 likewise discloses a shaped sheet metal part and a process for producing such a shaped sheet metal part.

Against the background of the prior art, the problem addressed was that of further developing a flat steel product for hot forming such that, especially in conjunction with an aluminum-based anticorrosion coating, improved processing properties of the hot-formed shaped sheet metal part are achieved. In addition, a process by which such shaped sheet metal parts can be produced in practice was to be specified.

This object is achieved by the invention, in a first embodiment, by a flat steel product for hot forming, comprising a steel substrate composed of steel consisting of, as well as iron and unavoidable impurities, (in % by weight)

$$C : 0.06 - 0.5 \% \\ Si : 0.05 - 0.6 \% \\ Mn : 0.4 - 3. \% , \\ Al : 0.06 - 1. \% , \\ B : 0.0005 - 0.01 \% , \\ V : 0.01 - 0.5 \% \\ P : \leq 0.03 \% , S : \leq 0.02 \% , N : \leq 0.02 \% , Sn : \leq 0.03 \% , As : \leq 0.01 \%$$

and optionally one or more of the elements “Ce, La, Ti, Nb, Cr, Cu, Mo, Ni, Ca, W” in the following contents:

$$Ce + La : 0.01 - 0.03 \% , \\ Ti : 0.0005 - 0.1 \% , \\ Nb : 0.001 - 0.2 \% , \\ Cr : 0.01 - 1. \% \\ Cu : 0.01 - 0.2 \% , \\ Mo : 0.002 - 0.3 \% , \\ Ni : 0.01 - 0.5 \% , \\ Ca : 0.0005 - 0.005 \% , \\ W : 0.001 - 1. \% .$$

The steel substrate of the flat steel product of the invention has an aluminum content of at least 0.06% by weight, preferably at least 0.07% by weight, especially at least 0.08% by weight. The aluminum content is preferably at least 0.10% by weight, more preferably at least 0.11% by weight, especially at least 0.12% by weight, preferably at least 0.140% by weight, especially at least 0.15% by weight, preferably at least 0.16% by weight. The maximum aluminum content is 1.0% by weight, especially not more than 0.8% by weight, preferably not more than 0.50% by weight, especially not more than 0.35% by weight, preferably not more than 0.25% by weight, especially not more than 0.24% by weight.

Aluminum (“Al”) is known to be added as deoxidant in steelmaking. Reliable binding of the oxygen present in the steel melt requires at least 0.01% by weight of Al. Furthermore, Al may additionally be used for binding of contents of N that are unwanted but unavoidable for production-related reasons. Comparatively high aluminum contents have been avoided to date since the Ac3 temperature also moves upward with the aluminum content. This has an adverse effect on austenitization, which is important for hot forming. Moreover, over and above contents of about 0.24% by weight, there can be a gradual deterioration in the weldability of the hot-formed component. Therefore, the Al content is preferably limited at the upper end according to the paragraph above, for example to a maximum of 0.35% by weight. Moreover, an elevated aluminum content leads to a rise in the martensite start temperature and the requisite critical cooling rate in the hot forming process, which makes it more complex. However, it has been found that elevated aluminum contents (i.e. aluminum contents of at least 0.06% by weight or more) surprisingly lead to positive effects, especially in conjunction with an aluminum-based anticorrosion coating.

In the course of coating of the flat steel product with an aluminum-based anticorrosion coating and in the course of the subsequent hot forming of sheet metal blanks divided therefrom to give shaped sheet metal parts, there is diffusion of iron from the steel substrate into the liquid anticorrosion coating. In the interdiffusion zone, this forms iron aluminide compounds having relatively high density via a multistage phase transformation (Fe2Al5→Fe2Al→FeAl→Fe3Al). The formation of such denser phases is associated with higher aluminum consumption than in less dense phases. This locally higher aluminum consumption leads to formation of pores (defect sites) in the resultant phase. These pores are preferably formed in the transition region between steel substrate and anticorrosion coating, where the proportion of aluminum available is shaped to a high degree by the aluminum content of the steel substrate. There may especially be an accumulation of pores in the form of a band in the transition region.

Such pores and especially a band of pores cause a variety of problems:
The pores reduce mechanical integrity in this region. There may be faster layer detachment under corrosive stress.
   Moreover, there is a reduction in the transmissible force at the bonding site of two components after adhesive bonding or welding.
The pores lead to altered current pathways in the material in resistance point welding, which adversely affect suitability for welding and hence reduce the welding range.
Even the pores themselves facilitate initiation and propagation of cracking on static and dynamic bending.

It has been found that, surprisingly, increasing the aluminum content (“Al”) in the steel substrate to the lower limits described or higher can achieve a distinct reduction in pore formation on coating with an aluminum-based anticorrosion coating and subsequent hot forming. Especially in the transition region between steel substrate and anticorrosion coating, the locally higher aluminum consumption in the case of formation of denser iron aluminide compounds can be at least partly compensated for by the aluminum content of the steel substrate, such that the formation of pores, especially a band of pores, is suppressed.

In the case of an excessively high Al content, especially in the case of contents of more than 1.0% by weight of Al, there is a risk that Al oxides will form at the surface of a product manufactured from steel material alloyed in accordance with the invention, which would worsen wetting characteristics in the hot dip coating operation. Moreover, in the case of relatively high Al contents, the formation of nonmetallic Al-based inclusions is favored, which, as coarse inclusions, have an adverse effect on crash characteristics. Moreover, an excessively high aluminum content can in turn lead to significant diffusion into the coating. This would correspondingly lower the silicon content in the anticorrosion coating, which could impair the functioning of the anticorrosion coating. Therefore, the Al content is preferably chosen below the upper limits already mentioned.

Bending characteristics in particular are reported here by the addition of vanadium (“V”). Vanadium is present in the steel of the flat steel product in contents of 0.010-0.50% by weight. Over and above a vanadium content of 0.010% by weight, vanadium carbonitrides are formed to an increased degree. These act as traps for the hydrogen present in the steel, which would otherwise cause embrittlement of steel. The vanadium content is preferably at least 0.020% by weight, especially at least 0.030% by weight, more preferably at least 0.050% by weight.

The stated vanadium content (just like the optional niobium content elucidated later on), especially in the process described hereinafter for production of a flat steel product for hot forming having an anticorrosion coating, leads to a distribution of vanadium carbonitrides (or niobium carbonitrides) that leads to a particularly fine hardening structure in the subsequent hot forming operation. During the cooling after the hot dip coating operation, the coated flat steel product is kept within a temperature range between 400° C. and 300° C. for a certain period of time. Within this temperature range, there is still a certain diffusion rate of carbon (“C”) within the steel substrate, while thermodynamic solubility is very low. Carbon thus diffuses to and collects at lattice defects. Lattice defects are especially caused by dissolved vanadium or niobium atoms, which expand the atomic lattice by virtue of their much higher atomic volume and hence increase the size of tetrahedral and octahedral gaps in the atomic lattice, such that the local solubility of C is increased. Consequently, clusters of carbon and vanadium or niobium arise in the steel substrate, and are then transformed to very fine precipitates in the subsequent austenitization step of hot forming and act as additional austenite grains. Therefore, the result is a refined austenite structure with relatively small austenite grains and hence also a refined hardness structure.

This especially also relates to the ferritic interdiffusion layer that forms in the hot forming. The refined ferritic structure in the interdiffusion layer assists reduction in the tendencies to initiate cracking under flexural stresses.

Moreover, the vanadium carbonitrides also precipitate during the hot forming process, for example in the course of transfer from the heating device to the forming tool or in the course of cooling after removal from the forming tool, and hence cause a high amount of particularly fine precipitates. These fine precipitates have a particularly advantageous effect on strength and hydrogen stability.

Increasingly coarser precipitates are formed at higher vanadium contents. Such coarser precipitates can cause relatively marked distortions in the surrounding structure, which can in turn lead to accumulation of hydrogen and hence have more of a counterproductive effect, whereas finely distributed carbide formation permanently binds relatively large amounts of hydrogen present. Moreover, addition of high levels of vanadium is economically unviable. For good bending characteristics and in particular high stability to hydrogen embrittlement, the vanadium content is preferably not more than 0.50% by weight, especially not more than 0.30% by weight, preferably not more than 0.20% by weight, especially preferably 0.1% by weight, more preferably 0.08% by weight.

The elements vanadium, niobium and titanium all form precipitates that contribute to grain refining. Because of their different solubilities, however, the precipitates occur at different temperatures. Titanium nitrides have the lowest solubility in austenite and therefore already precipitate out at very high temperatures and lower the grain growth of austenite. Nb precipitates from moderate temperatures, and vanadium only below about 900° C. This means that vanadium leads to particularly fine precipitates. The contents of the three elements should therefore be adjusted accurately to one another and to the cooling process.

Optionally, the steel in the flat steel product of the invention has a content of cerium (“Ce”) and lanthanum (“La”) of greater than 0.01% by weight. What is meant by the statement that Ce+La is greater or less than a particular value is that either cerium or lanthanum is present in the steel, or that cerium and lanthanum are present simultaneously, where the sum total of the contents of cerium and lanthanum in all three cases is greater or less than the value determined. Therefore,

$$Ce + La : 0.01 - 0.03 \% by weight$$

means that either cerium or lanthanum is present in the steel or both cerium and lanthanum are present, where the sum total of the contents of cerium and lanthanum is in the range of 0.01-0.03% by weight. The content of Ce+La is preferably at least 0.010% by weight, especially at least 0.015% by weight. Further preferably, the content of Ce+La is not more than 0.025% by weight. Cerium and lanthanum are chemically very similar and therefore firstly have the same effect in steel and secondly are analytically distinguishable from one another only with great difficulty. Therefore, it is appropriate to consider merely the sum of the contents of cerium and lanthanum. Therefore, reference is also occasionally made to “cerium/lanthanum” hereinafter when what is meant is the addition of cerium and/or lanthanum.

It has been found that, surprisingly, even the addition of Ce+La in small amounts over and above 0.01% by weight has a positive effect on resistance to hydrogen embrittlement (and hence on bending characteristics). The corresponding addition results in formation of more efficient hydrogen traps. Studies have shown that this is caused by effects including the formation of spheroidal oxysulfides of Ce and/or La (e.g. Ce₂O₂S). The compounds of Ce and La already form at very high temperatures and are thermodynamically very stable. They additionally ensure the binding of oxygen and sulfur for small amounts of Al₂O₃, MnS and similar inclusions.

In the case of excessively high contents of Ce+La, there can be “clogging” of the immersed tube in the casting process. Therefore, the content of Ce+La is limited to 0.03% by weight.

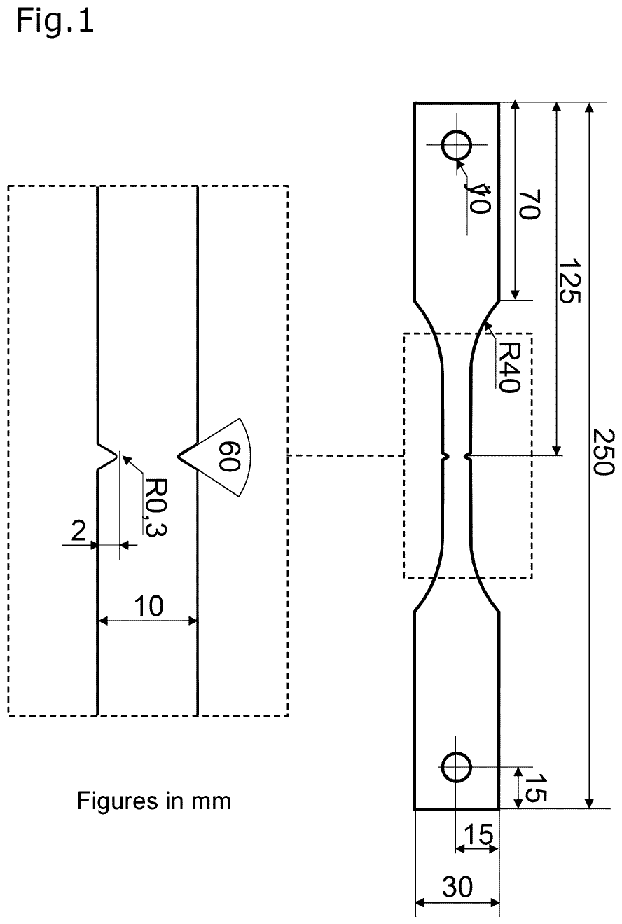

Stability to hydrogen embrittlement is ascertained by means of a modified slow strain rate test in accordance with DIN EN ISO 7539-7:2018-05. The testing speed was 0.1 μm/s. The measurement was conducted at room temperature. The sample geometry is shown in detail in FIG. 1, where the distances given in FIG. 1 should be considered to be in mm. Maximum breaking stress before sample failure was determined. In order to test the influence of hydrogen that has diffused in, the specimen was in the middle of the electrolyte cell, which was filled with an aqueous electrolyte having 0.025% NH4SCN (ammonium thiocyanate). The loading current density was −0.025 mA/cm². In this way, the specimen was laden with hydrogen before and during the measurement. The hydrogen loading was started 80 minutes before the mechanical stress and maintained until the sample failed. This ensured a homogeneous hydrogen concentration at the start of the test and prevented release of the hydrogen during the test. The breaking stress ascertained in this test serves as a measure of resistance to hydrogen embrittlement.

Overall, the additions of aluminum, vanadium and cerium/lanthanum each have a positive effect on bending characteristics. More preferably, both aluminum and vanadium and cerium and/or lanthanum are included in the alloy. However, even the inclusion of two of these three substances in the alloy brings about an improvement over the prior art. Therefore, the object is already achieved by the addition of aluminum and vanadium, as elucidated in the first embodiment described above. The inclusion of vanadium and cerium/lanthanum in the alloy (even without aluminum) likewise leads to improved fracture characteristics. Therefore, the object of the invention is likewise achieved by the second embodiment that follows.

In this second embodiment, the object of the invention is achieved by a flat steel product for hot forming, comprising a steel substrate composed of steel consisting of, as well as iron and unavoidable impurities, (in % by weight)

$$C : 0.06 - 0.5 \% \\ Si : 0.05 - 0.6 \% \\ Mn : 0.4 - 3. \% , \\ B : 0.0005 - 0.01 \% , \\ V : 0.01 - 0.5 \% \\ P : \leq 0.03 \% , \\ S : \leq 0.02 \% , \\ N : \leq 0.02 \% , \\ Sn : \leq 0.03 \% , \\ As : \leq 0.01 \% \\ Ce + La : 0.01 - 0.03 \% ,$$

and optionally one or more of the elements “Al, Ti, Nb, Cr, Cu, Mo, Ni, Ca, W” in the following contents:

$$Al : \leq 1. \% ,$$

$$Ti : 0.0005 - 0.1 \% ,$$

$$Nb : 0.001 - 0.2 \% ,$$

$$Cr : 0.01 - 1. \% ,$$

$$Cu : 0.01 - 0.2 \% ,$$

$$Mo : 0.002 - 0.3 \% ,$$

$$Ni : 0.01 - 0.5 \% ,$$

$$Ca : 0.0005 - 0.005 \% ,$$

$$W : 0.001 - 1. \% .$$

For vanadium and cerium/lanthanum, which are obligatory in the second embodiment, the same preferred ranges are applicable as in the first embodiment. For aluminum, which is optional here, the optional aluminum content is preferably at least 0.01% by weight, especially at least 0.03% by weight, more preferably at least 0.06% by weight, preferably at least 0.07% by weight, especially at least 0.08% by weight. The aluminum content is preferably at least 0.10% by weight, more preferably at least 0.11% by weight, especially at least 0.12% by weight, preferably at least 0.140% by weight, especially at least 0.15% by weight, preferably at least 0.16% by weight. The maximum aluminum content is 1.0% by weight, especially not more than 0.8% by weight, preferably not more than 0.50% by weight, especially not more than 0.35% by weight, preferably not more than 0.25% by weight, especially not more than 0.24% by weight.

The observations that follow in respect of the different elements and their preferred ranges are applicable both to the first embodiment and to the second embodiment.

Carbon (“C”) is present in the steel substrate of the flat steel product in contents of 0.06-0.5% by weight. C contents set at such a level contribute to hardenability of the steel in that they delay ferrite and bainite formation and stabilize the residual austenite in the structure. A C content of at least 0.06% by weight is required in order to achieve sufficient hardenability and associated high strength.

However, high C contents can adversely affect weldability. In order to improve weldability, the C content can be adjusted to 0.5% by weight, preferably to not more than 0.5% by weight, especially to not more than 0.45% by weight, preferably to 0.42% by weight, more preferably 0.40% by weight, preferably not more than 0.38% by weight, especially not more than 0.35% by weight, preferably not more than 0.33% by weight. Further preferably, the C content is at least 0.20% by weight, especially at least 0.25% by weight, preferably at least 0.30% by weight, especially at least 0.31% by weight.

Silicon (“Si”) is used to further increase the hardenability of the flat steel product and the strength of the press-hardened product via solid solution strengthening. Silicon also enables the use of ferro-silico-manganese as alloying agent, which has a beneficial effect on production costs. A hardening effect is already established over and above an Si content of 0.05% by weight. A significant rise in strength occurs over and above an Si content of at least 0.10% by weight, especially at least 0.15% by weight. Moreover, silicon is a comparatively inexpensive alloy element, and so it is economically advantageous to use Si to increase strength. Si contents above 0.6% by weight have a disadvantageous effect on coating characteristics, especially in the case of Al-based coatings. Si contents of not more than 0.50% by weight, especially not more than 0.30% by weight, preferably not more than 0.25% by weight, are preferably established in order to improve the surface quality of the coated flat steel product.

Manganese (“Mn”) acts as a hardening element in that it significantly delays ferrite and bainite formation. In the case of manganese contents of less than 0.4% by weight, during press hardening, significant proportions of ferrite and bainite are formed even in the case of very rapid cooling rates, which should be avoided. Mn contents of at least 0.5% by weight, especially at least 0.7% by weight, preferably at least 0.8% by weight, especially of at least 0.9% by weight, more preferably of at least 1.0% by weight, especially at least 1.05% by weight, are advantageous when a martensitic structure is to be ensured, especially in regions of relatively high forming. Mn contents of more than 3.0% by weight have an adverse effect on processing properties, and therefore the Mn content of flat steel products of the invention is limited to not more than 3.0% by weight, preferably not more than 2.5% by weight. Weldability in particular is greatly restricted, and therefore the Mn content is limited preferably to not more than 1.6% by weight and especially to 1.30% by weight, especially to not more than 1.20% by weight. Manganese contents of not more than 1.6% by weight are additionally also preferred for economic reasons.

Boron (“B”) is included in the alloy in order to improve the hardenability of the flat steel product in that boron atoms or boron precipitates adjoining austenite grain boundaries reduce the grain boundary energy, which suppresses the nucleation of ferrite during press hardening. A distinct effect on hardenability occurs in the case of B contents of at least 0.0005% by weight, preferably at least 0.0007% by weight, especially at least 0.0010% by weight, especially at least 0.0020% by weight. In the case of B contents exceeding 0.01% by weight, by contrast, there is increased formation of boron carbides, boron nitrides or boron nitrocarbides, which in turn constitute preferred nucleation sites for the nucleation of ferrite and lower the hardening effect again. For that reason, the boron content is limited to not more than 0.01% by weight, preferably not more than 0.0100% by weight, preferably not more than 0.0050% by weight, especially not more than 0.0035% by weight, especially not more than 0.0030% by weight, preferably not more than 0.0025% by weight.

Phosphorus (“P”) and sulfur (“S”) are elements that are introduced into the steel as impurities by iron ore and cannot be eliminated entirely in the industrial scale steelworks process. The P content and the S content should be kept as low as possible due to the deterioration in mechanical properties, for example notched impact resistance, with increasing P content or S content. Moreover, there is incipient embrittlement of the martensite over and above P contents of 0.03% by weight, and therefore the P content of a flat steel product of the invention is limited to not more than 0.03% by weight, especially not more than 0.02% by weight. The S content of a flat steel product of the invention is limited to not more than 0.02% by weight, preferably not more than 0.0010% by weight, especially not more than 0.005% by weight.

Nitrogen (“N”) is likewise present as an impurity in the steel in small amounts owing to the steel manufacturing process. The N content should be kept as low as possible and should be not more than 0.02% by weight. Especially in the case of alloys containing boron, nitrogen is harmful since the formation of boron nitrides prevents the transformation-retarding effect of boron, and therefore the nitrogen content in this case should preferably be not more than 0.010% by weight, especially not more than 0.007% by weight.

Further typical impurities are tin (“Sn”) and arsenic (“As”). The Sn content is not more than 0.03% by weight, preferably not more than 0.02% by weight. The As content is not more than 0.01% by weight, especially not more than 0.005% by weight.

As well as the above-elucidated impurities P, S, N, Sn and As, it is also possible for further elements to be present in the steel as impurities. These further elements are combined under the “unavoidable impurities”. The content of these “unavoidable impurities” preferably adds up to not more than 0.2% by weight, preferably not more than 0.1% by weight. The optional alloy elements Ce, La, Ti, Nb, Cr, Cu, Mo, Ni, Ca and W described hereinafter for which a lower limit is specified may also be present in the steel substrate as unavoidable impurities in contents below the respective lower limit. In that case, they are likewise counted among the “unavoidable impurities”, the total content of which is limited to not more than 0.2% by weight, preferably not more than 0.1% by weight.

Cerium, lanthanum, titanium, niobium, chromium, copper, molybdenum, nickel, calcium and tungsten, in the first embodiment, may optionally each be included in the alloy individually or in combination with one another in the steel of a flat steel product of the invention.

Aluminum, titanium, niobium, chromium, copper, molybdenum, nickel, calcium and tungsten, in the second embodiment, may optionally each be included in the alloy individually or in combination with one another in the steel of a flat steel product of the invention.

Titanium (“Ti”) is a microalloy element which is optionally included in the alloy in order to contribute to grain refining, and at least 0.0005% by weight of Ti, especially at least 0.0010% by weight, preferably at least 0.010% by weight of Ti, should be added for sufficient availability. There is a distinct deterioration in cold rollability and recrystallizability over and above 0.10% by weight of Ti, and therefore any greater Ti contents should be avoided. In order to improve cold rollability, the Ti content may be limited preferably to 0.08% by weight, especially to 0.038% by weight, more preferably to 0.020% by weight, especially 0.015% by weight. Titanium additionally has the effect of binding nitrogen and hence making it possible for boron to display its greatly ferrite-inhibiting effect.

The bending characteristics of the sheet metal component are even further improved by the optional addition of niobium (“Nb”) in contents of at least 0.001% by weight. The Nb content is preferably at least 0.005% by weight, especially at least 0.010% by weight, preferably at least 0.015% by weight, more preferably at least 0.020% by weight.

The mechanism of action of niobium has already been elucidated in connection with vanadium, since the mechanisms are analogous for both elements.

However, too high an Nb content leads to worsened recrystallizability. Therefore, the Nb content is not more than 0.2% by weight. Further preferably, the Nb content is not more than 0.20% by weight, especially not more than 0.15% by weight, preferably not more than 0.10% by weight, especially not more than 0.05% by weight, preferably not more than 0.04% by weight, especially not more than 0.030% by weight.

Aluminum, niobium and vanadium have an influence on grain refining in austenitization in the hot forming process. It has been found that aluminum, as well as niobium, especially refines grain growth at elevated temperatures in austenite (for example at more than 1200° C.) via comparatively early formation (i.e. taking place at relatively high temperatures) of AlN. The formation of AlN is thermodynamically favored over the formation of NbN or NbC and VN or VC. The precipitation of AlN has a grain-refining effect here in austenite and hence a toughness-improving effect. Rising ratios of Al to the sum total of the contents of Nb and V improve this effect. It is therefore optionally the case that, for the Al/(Nb+V) ratio of Al content to the sum total of the contents of Nb and V:

$$1 \leq Al / ( Nb + V ) ;$$

preferably, the Al/Nb ratio≥2. At the same time, too large a ratio of Al/(Nb+V) has the effect that AlN formation is no longer as advantageously fine, and increasingly coarser AlN particles instead occur, which again reduces the grain refining effect. It is therefore advantageous optionally to establish a ratio of Al/(Nb+V) for which:

$$Al / ( Nb + V ) \leq 30.$$

Preferably, the Al/(Nb+V) ratio is ≤20.0, especially ≤16.0, preferably ≤14.0, more preferably ≤12.0, especially ≤10.0, preferably ≤8.0, especially ≤6.0, preferably ≤4.0.

Optionally present chromium (“Cr”) suppresses the formation of ferrite and pearlite during accelerated cooling of a flat steel product of the invention and enables complete martensite formation even in the case of relatively low cooling rates, which achieves an increase in hardenability.

These stated effects are established over and above a content of 0.01% by weight, and a content of at least 0.10% by weight, preferably at least 0.15% by weight, has been found to be useful for reliable processing in practice. However, excessively high contents of Cr impair the coatability of the steel. Therefore, the Cr content of the steel of a steel substrate is limited to not more than 1.0% by weight, preferably not more than 0.80% by weight, especially not more than 0.75% by weight, preferably not more than 0.50% by weight, especially not more than 0.30% by weight.

Copper (“Cu”) may optionally be included in the alloy in order to increase hardenability in the case of additions of at least 0.01% by weight, preferably at least 0.010% by weight, especially at least 0.015% by weight. In addition, copper improves the resistance to atmospheric corrosion of uncoated sheets or cut edges. In the case of an excessively high Cu content, there is a distinct deterioration in hot rollability owing to low-melting Cu phases at the surface, and therefore the Cu content is limited to not more than 0.2% by weight, preferably not more than 0.1% by weight, especially not more than 0.10% by weight.

Molybdenum (“Mo”) may optionally be added in order to improve process stability, since it distinctly slows ferrite formation. Over and above contents of 0.002% by weight, there is dynamic formation of molybdenum-carbon clusters up to and including ultrafine molybdenum carbides at the grain boundaries, which distinctly slow the mobility of the grain boundary and hence diffusive phase transformations. Moreover, molybdenum reduces grain boundary energy, which reduces the nucleation rate of ferrite. The Mo content is preferably at least 0.004% by weight, especially at least 0.01% by weight. Because of the high costs associated with alloying of molybdenum, the Mo content should be not more than 0.3% by weight, preferably not more than 0.20% by weight, especially not more than 0.15% by weight, especially not more than 0.10% by weight, preferably not more than 0.08% by weight.

Nickel (“Ni”) stabilizes the austenitic phase and may optionally be included in the alloy in order to reduce the Ac3 temperature and to suppress the formation of ferrite and bainite. Nickel additionally has a positive influence on hot rollability, especially when the steel contains copper. Copper worsens hot rollability. In order to counter the adverse effect of copper on hot rollability, it is possible to include 0.01% by weight of nickel in the alloy as part of the steel; the Ni content is preferably at least 0.015% by weight. For economic reasons, the nickel content should remain limited to not more than 0.5% by weight, especially not more than 0.20% by weight. The Ni content is preferably not more than 0.10% by weight.

Calcium (“Ca”) in steels serves for indentation of nonmetallic inclusions, especially of manganese sulfides. Rounded indentation distinctly reduces the adverse effect of the inclusions on hot formability, sustained strength and toughness. In order to utilize this effect in the case of a flat steel product of the invention as well, a flat steel product of the invention may optionally contain at least 0.0005% by weight of Ca, especially at least 0.0010% by weight, preferably at least 0.0020% by weight. The maximum Ca content is 0.01% by weight, especially not more than 0.007% by weight, preferably not more than 0.005% by weight. In the case of excessively high Ca contents, there is a growing probability that nonmetallic inclusions involving Ca will form, which worsen the purity of the steel and also the toughness thereof. For that reason, an upper limit in the Ca content of not more than 0.005% by weight, preferably not more than 0.003% by weight, especially not more than 0.002% by weight, preferably not more than 0.001% by weight, should be observed.

Tungsten (“W”) may optionally be included in the alloy in contents of 0.001-1.0% by weight in order to slow ferrite formation. A positive effect on hardenability already arises in the case of W contents of at least 0.001% by weight. For reasons of cost, not more than 1.0% by weight of tungsten is included in the alloy.

In preferred developments, the sum total of the Mn content and the Cr content (“Mn+Cr”) is more than 0.7% by weight, especially more than 0.8% by weight, preferably more than 1.1% by weight. Below a minimum sum total of the two elements, the necessary transformation-inhibiting action thereof is lost. Irrespective of that, the sum total of the Mn content and the Cr content is less than 3.5% by weight, preferably less than 2.5% by weight, especially less than 2.0% by weight, more preferably less than 1.5% by weight. The above upper limits for the two elements are the result of assurance of coating performance and for assurance of adequate welding characteristics.

The above elucidations relating to element contents and preferred limits thereof for the first and second embodiments are correspondingly applicable to the process described hereinafter for production of a flat steel product, to the shaped sheet metal part and to the process for producing a shaped sheet metal part.

The flat steel product preferably comprises an anticorrosion coating in order to protect the steel substrate from oxidation and corrosion in the hot forming operation and in the use of the steel component produced.

In a specific embodiment, the flat steel product preferably comprises an aluminum-based anticorrosion coating. This anticorrosion coating may have been applied on one or both sides of the flat steel product. “Both sides of the flat steel product” refer to the two opposite large faces of the flat steel product. The narrow faces are referred to as edges.

Such an anticorrosion coating is preferably created by hot dip coating of the flat steel product. This involves conducting the flat steel product through a liquid melt consisting of 0.1-15% by weight of Si, preferably more than 1.0% by weight of Si, optionally 2-4% by weight of Fe, optionally up to 5% by weight of alkali metals or alkaline earth metals, preferably up to 1.0% by weight of alkali metals or alkaline earth metals, and optionally up to 15% by weight of Zn, preferably up to 10% by weight of Zn, and optional further constituents, the contents of which are limited to a total of not more than 2.0% by weight, and aluminum as the balance.

In a preferred variant, the Si content of the melt is 1.0-3.5% by weight or 7-12% by weight, especially 8-10% by weight.

In a preferred variant, the optional content of alkali metals or alkaline earth metals in the melt comprises 0.1-1.0% by weight of Mg, especially 0.1-0.7% by weight of Mg, preferably 0.1-0.5% by weight of Mg. In addition, the optional content of alkali metals or alkaline earth metals in the melt may especially comprise at least 0.0015% by weight of Ca, especially at least 0.01% by weight of Ca.

In the case of hot dip coating, iron diffuses out of the steel substrate into the liquid coating, such that the anticorrosion coating of the flat steel product on solidification especially has an alloy layer and an Al base layer.

The alloy layer lies atop and directly adjoins the steel substrate. The alloy layer is formed essentially from aluminum and iron. The other elements from the steel substrate or the melt composition do not accumulate significantly in the alloy layer. The alloy layer preferably consists of 35-60% by weight of Fe, preferably α-iron, optional further constituents, the contents of which are limited to a total of not more than 5.0% by weight, preferably 2.0% by weight, and aluminum as the balance, where the Al content preferably rises in surface direction. The optional further constituents especially include the other constituents of the melt (i.e. silicon and optionally alkali metals or alkaline earth metals, especially Mg and Ca) and the other components of the steel substrate in addition to iron.

The Al base layer lies atop and directly adjoins the alloy layer. The composition of the Al base layer preferably corresponds to the composition of the melt in the melt bath. This means that it consists of 0.1-15% by weight of Si, optionally 2-4% by weight of Fe, optionally up to 5.0% by weight of alkali metals or alkaline earth metals, preferably up to 1.0% by weight of alkali metals or alkaline earth metals, optionally up to 15% by weight of Zn, preferably up to 10% by weight of Zn, and optional further constituents, the contents of which are limited to a total of not more than 2.0% by weight, and aluminum as the balance.

In a preferred variant of the Al base layer, the optional content of alkali metals or alkaline earth metals comprises 0.1-1.0% by weight of Mg, especially 0.1-0.7% by weight of Mg, preferably 0.1-0.5% by weight of Mg. In addition, the optional content of alkali metals or alkaline earth metals in the Al base layer may especially comprise at least 0.0015% by weight of Ca, especially at least 0.1% by weight of Ca.

In a further-preferred variant of the anticorrosion coating, the Si content in the alloy layer is lower than the Si content in the Al base layer.

The anticorrosion coating preferably has a thickness of 5 to 60 μm, especially of 10 to 40 μm. The coat weight of the anticorrosion coating is especially

$$30 - 360 \frac{g}{{m}^{2}}$$

in the case of double-sided anticorrosion coatings or

$$15 - 180 \frac{g}{{m}^{2}}$$

in the case of the single-sided variant. The coat weight of the anticorrosion coating is preferably

$$100 - 200 \frac{g}{{m}^{2}}$$

in the case of double-sided coatings or

$$50 - 100 \frac{g}{{m}^{2}}$$

for single-sided coatings. The coat weight of the anti-corrosion coating is more preferably

$$120 - 180 \frac{g}{{m}^{2}}$$

in the case of double-sided coatings or

$$60 - 90 \frac{g}{{m}^{2}}$$

for single-sided coatings.

The thickness of the alloy layer is preferably less than 20 μm, more preferably less than 16 μm, especially less than 12 μm, more preferably less than 10 μm, preferably less than 8 μm, especially less than 5 μm. The thickness of the Al base layer is found from the difference in the thicknesses of anticorrosion coating and alloy layer. The thickness of the Al base layer even in the case of thin anticorrosion coatings is preferably at least 1 μm.

In a preferred variant, the flat steel product comprises an oxide layer disposed atop the anticorrosion coating. The oxide layer lies in particular atop the Al base layer and preferably forms the outer conclusion of the anticorrosion coating.

The oxide layer consists especially to an extent of more than 80% by weight of oxides, where the majority of the oxides (i.e. more than 50% by weight of the oxides) is aluminum oxide. The oxide layer optionally includes, in addition to aluminum oxide, hydroxides and/or magnesium oxide alone or as a mixture. The remainder of the oxide layer not accounted for by the oxides and optionally present hydroxides preferably consists of silicon, aluminum, iron and/or magnesium in metallic form. For the optional embodiment with zinc as a constituent of the Al base layer, zinc oxide constituents are also present in the oxide layer.

The oxide layer of the flat steel product preferably has a thickness greater than 50 nm. In particular, the thickness of the oxide layer is not more than 500 nm.

In an alternative configuration, the flat steel product comprises a zinc-based anticorrosion coating. This anticorrosion coating may have been applied on one or both sides of the flat steel product. “Both sides of the flat steel product” refer to the two opposite large faces of the flat steel product. The narrow faces are referred to as edges.

Such a zinc-based anticorrosion coating preferably comprises 0.2-6.0% by weight of Al, 0.1-10.0% by weight of Mg, optionally 0.1-40% by weight of manganese or copper, optionally 0.1-10.0% by weight of cerium, optionally not more than 0.2% by weight of further elements, unavoidable impurities, and zinc as the balance. In particular, the Al content is not more than 2.0% by weight, preferably not more than 1.5% by weight. The Mg content is especially not more than 3.0% by weight, preferably not more than 1.0% by weight. The anticorrosion coating may be applied by hot dip coating or by physical gas phase deposition or by electrolytic methods.

In addition, the yield point of a particularly refined flat steel product has a continuous progression or is only slightly pronounced. What is meant by a continuous progression in the context of the application is that there is no pronounced yield point. A yield point with continuous progression can also be referred to as yield point Rp0.2. A slightly pronounced yield point in the present context is understood to mean a pronounced yield point where the difference ARe between the upper yield point limit ReH and lower yield point limit ReL is not more than 50 MPa. Accordingly:

$$Δ Re = ( ReH - ReL ) \leq 50 MPa with ReH = upper yield point in MPa and ReL = lower yield point in MPa .$$

The process of the invention for producing a flat steel product for hot forming with an anticorrosion coating, comprising the following steps:
a) providing a slab or thin slab which consists of steel consisting of, as well as iron and unavoidable impurities, (in % by weight)

$$C : 0.06 - 0.5 \% ,$$

$$Si : 0.05 - 0.6 \% ,$$

$$Mn : 0.4 - 3. \% ,$$

$$Al : 0.06 - 1. \% ,$$

$$B : 0.0005 - 0.01 \% ,$$

$$V : 0.01 - 0.5 \% ,$$

$$P : \leq 0.03 \% ,$$

$$S : \leq 0.02 \% ,$$

$$N : \leq 0.02 \% ,$$

$$Sn : \leq 0.03 \% ,$$

$$As : \leq 0.01 \%$$

and optionally one or more of the elements “Ce, La, Nb, Cr, Cu, Mo, Ni, Ca, W” in the following contents:

$$Ce + La : 0.01 - 0.03 \% ,$$

$$Ti : 0.0005 - 0.1 \% ,$$

$$Nb : 0.001 - 0.2 \% ,$$

$$Cr : 0.01 - 1. \% ,$$

$$Cu : 0.01 - 0.2 \% ,$$

$$Mo : 0.002 - 0.3 \% ,$$

$$Ni : 0.01 - 0.5 \% ,$$

$$Ca : 0.0005 - 0.005 \% ,$$

$$W : 0.001 - 1. \% ,$$

$$or of$$

$$C : 0.06 - 0.5 \% ,$$

$$Si : 0.05 - 0.6 \% ,$$

$$Mn : 0.4 - 3. \% ,$$

$$B : 0.0005 - 0.01 \% ,$$

$$V : 0.01 - 0.5 \% ,$$

$$P : \leq 0.03 \% ,$$

$$S : \leq 0.02 \% ,$$

$$N : \leq 0.02 \% ,$$

$$Sn : \leq 0.03 \% ,$$

$$As : \leq 0.01 \% ,$$

$$Ce + La : 0.01 - 0.03 \% ,$$

and optionally one or more of the elements “Al, Nb, Cr, Cu, Mo, Ni, Ca, W” in the following contents:

$$Al : \leq 1. \% ,$$

$$Ti : 0.0005 - 0.1 \% ,$$

$$Nb : 0.001 - 0.2 \% ,$$

$$Cr : 0.01 - 1. \% ,$$

$$Cu : 0.01 - 0.2 \% ,$$

$$Mo : 0.002 - 0.3 \% ,$$

$$Ni : 0.01 - 0.5 \% ,$$

$$Ca : 0.0005 - 0.005 \% ,$$

$$W : 0.001 - 1. \% ;$$

b) through-heating the slab or thin slab at a temperature (T1) of 1100-1400° C.;
c) optionally pre-rolling the through-heated slab or thin slab to give an intermediate product having an intermediate product temperature (T2) of 1000-1200° C.;
d) hot rolling to give a hot-rolled flat steel product, where the final rolling temperature (T3) is 750-1000° C.;
e) optionally coiling the hot-rolled flat steel product, where the coiling temperature (T4) is not more than 700° C.;
f) optionally descaling the hot-rolled flat steel product;
g) optionally cold-rolling the flat steel product, where the degree of cold rolling is at least 30%;
h) annealing the flat steel product at an annealing temperature (T5) of 650-900° C.;
i) cooling the flat steel product to an immersion temperature (T6) of 650-800° C., preferably 670-800° C.;
j) coating the flat steel product having an anticorrosion coating that has been cooled to the immersion temperature by hot dip coating in a melt bath having a melt temperature (T7) of 660-800° C., preferably 680-740° C.;
k) cooling the coated flat steel product to room temperature, where the first cooling period t_{MT} in the temperature range between 600° C. and 450° C. is more than 10 s, especially more than 14 s, and the second cooling period t_{LT} in the temperature range between 400° C. and 300° C. is more than 8 s, especially more than 12 s;
l) optionally skin pass rolling the coated flat steel product.

In step a), a semifinished product of a composition in accordance with the alloy defined in accordance with the invention for the flat steel product is provided. This may be a slab produced by conventional continuous slab casting or by continuous thin slab casting.

In step b), the semifinished product is through-heated at a temperature (T1) of 1100-1400° C. If the semifinished product is to be cooled after the casting, the semifinished product is first reheated to 1100-1400° C. for through-heating. The through-heating temperature should be at least 1100° C. in order to ensure good formability for the subsequent rolling process. The through-heating temperature should not be more than 1400° C. in order to avoid fractions of molten phases in the semifinished product.

In the optional step c), the semifinished product is pre-rolled to an intermediate product. Thin slabs are typically not subjected to any pre-rolling. Thick slabs that are to be rolled out to hot strips can be subjected to pre-rolling if required. In that case, the temperature of the intermediate product (T2) at the end of the pre-rolling should be at least 1000° C. in order that the intermediate product contains sufficient heat for the subsequent step of finish rolling. However, high rolling temperatures can also promote grain growth during the rolling operation, which has an adverse effect on the mechanical properties of the flat steel product. In order to minimize grain growth during the rolling operation, the temperature of the intermediate product at the end of the pre-rolling should not be more than 1200° C.

In step d), the slab or thin slab or, if step c) has been performed, the intermediate product is rolled to give a hot-rolled flat steel product. If step c) has been performed, the intermediate product is typically finish-rolled immediately after the pre-rolling. The finish-rolling typically commences no later than 90 s after the end of the pre-rolling. The slab, the thin slab or, if step c) has been performed, the intermediate product are rolled to completion at a final rolling temperature (T3). The final rolling temperature, i.e. the temperature of the completely hot-rolled flat steel product at the end of the hot rolling operation, is 750-1000° C. In the case of final rolling temperatures of less than 750° C., the amount of free vanadium decreases, since relatively large amounts of vanadium carbides are precipitated. The vanadium carbides that precipitate in the course of finish rolling are very large. They typically have an average grain size of 30 nm or more and are no longer dissolved in subsequent annealing processes, as conducted prior to hot dip coating, for example. The final rolling temperature is limited to values of not more than 1000° C. in order to prevent coarsening of the austenite grains. Moreover, final rolling temperatures of not more than 1000° C. are of relevance for process technology purposes in order to establish coiling temperatures (T4) of less than 700° C.

The hot rolling of the flat steel product can be effected in the form of a continuous hot strip rolling operation or of a reversing rolling operation. Step e) in the case of continuous hot strip rolling provides for optional coiling of the hot-rolled flat steel product. For this purpose, the hot strip, after the hot rolling, is cooled down to a coiling temperature (T4) within less than 50 s. The cooling medium used for this purpose may, for example, be water, air or a combination of the two. The coiling temperature (T4) should be not more than 700° C. in order to avoid the formation of large vanadium carbides. There is in principle no lower limit to the coiling temperature. However, coiling temperatures of at least 500° C. have been found to be favorable for cold rollability. Subsequently, the coiled hot strip is cooled down to room temperature in a conventional manner under air.

In step f), the hot-rolled flat steel product is optionally descaled in a conventional manner by pickling or by another suitable treatment.

The descaled hot-rolled flat steel product, prior to the annealing treatment in step g), may optionally be subjected to cold rolling in order, for example, to meet higher demands on the thickness tolerances of the flat steel product. The degree of cold rolling (DCR) should be at least 30% in order to introduce sufficient deformation energy into the flat steel product for rapid recrystallization. The degree of cold rolling DCR is understood to mean the quotient of the decrease in thickness on cold rolling ΔdCR divided by the hot strip thickness d:

$$DCR = Δ dCR / d$$

with ΔdCR=decrease in thickness on cold rolling in mm and d=hot strip thickness in mm, where the decrease in thickness ΔdCR is calculated from the difference in thickness of the flat steel product before cold rolling relative to the thickness of the flat steel product after cold rolling. The flat steel product before cold rolling is typically a hot strip of hot strip thickness d. The flat steel product after cold rolling is typically also referred to as cold strip. The degree of cold rolling may in principle assume very high values of more than 90%. However, degrees of cold rolling of not more than 80% have been found to be favorable for avoidance of strip cracks.

In step h), the flat steel product is subjected to an annealing treatment at annealing temperatures (T5) of 650-900° C. For this purpose, the flat steel product is first heated to the annealing temperature within 10 to 120 s and then kept at the annealing temperature for 30 to 600 s. The annealing temperature is at least 650° C., preferably at least 720° C. At annealing temperatures above 900° C. are not desirable for economic reasons.

In step i), the flat steel product, after the annealing, is cooled down to a dipping temperature (T6) in order to prepare it for the subsequent coating treatment. The dipping temperature is lower than the annealing temperature and is matched to the temperature of the melt bath. The dipping temperature is 600-800° C., preferably at least 650° C., more preferably at least 670° C., more preferably at most 700° C. For particularly homogeneous interfacial layer formation, it is important that there is adequate thermal energy in the interfacial layer between steel substrate and aluminum melt. This is not the case at temperatures lower than 600° C., such that unwanted compounds can form, the later reconversion of which can lead to pores. Over and above the preferred dipping temperatures, there is another significant increase in the diffusion rate of iron into aluminum, such that more iron can diffuse into the still-liquid interfacial layer even at the start of the coating process. The duration of the cooling of the annealed flat steel product from the annealing temperature T5 to the dipping temperature T6 is preferably 10-180 s. In particular, the dipping temperature T6 differs from the temperature of the melt bath T7 by not more than 30 K, especially not more than 20 K, preferably not more than 10 K.

The flat steel product is subjected to a coating treatment in step j). The coating treatment is preferably effected by continuous hot dip coating. The coating can be applied only on one side, on both sides or on all sides of the flat steel product. The coating treatment is preferably effected as a hot dip coating process, especially as a continuous process. The flat steel product typically comes into contact with the melt bath on all sides, such that it is coated on all sides. The melt bath containing the alloy to be applied to the flat steel product in liquid form is typically at a temperature (T7) of 660-800° C., preferably 680-740° C. Aluminum-based alloys have been found to be particularly suitable for coating of aging-resistant flat steel products with an anticorrosion coating. In such a case, the melt bath contains 0.1 to 15% by weight of Si, preferably more than 1.0% by weight of Si, optionally 2-4% by weight of Fe, optionally up to 5% by weight of alkali metals or alkaline earth metals, preferably up to 1.0% by weight of alkali metals or alkaline earth metals, and optionally up to 15% by weight of Zn, especially up to 10% by weight of Zn, and optional further constituents, the contents of which are limited to a total of not more than 2.0% by weight, and aluminum as the balance. In a preferred variant, the Si content of the melt is 1.0-3.5% by weight or 7-12% by weight, especially 8-10% by weight. In a preferred variant, the optional content of alkali metals or alkaline earth metals in the melt comprises 0.1-1.0% by weight of Mg, especially 0.1-0.7% by weight of Mg, preferably 0.1-0.5% by weight of Mg. In addition, the optional content of alkali metals or alkaline earth metals in the melt may especially comprise at least 0.0015% by weight of Ca, especially at least 0.01% by weight of Ca.

After the coating treatment, the coated flat steel product is cooled down to room temperature in step k). A first cooling period t_{MT} in the temperature range between 600° C. and 450° C. (moderate temperature range MT) is more than 5 s, preferably more than 10 s, especially more than 14 s, and a second cooling period t_{LT} in the temperature range between 400° C. and 300° C. (low temperature range LT) is more than 4 s, preferably more than 8 s, especially more than 12 s.

The first cooling period t_{MT} in the temperature range between 600° C. and 450° C. (moderate temperature range MT) may be achieved by gradual, continuous cooling or else by holding at a temperature for a certain time within this temperature range. Intermediate heating is even possible. All that is important is that the flat steel product remains within the temperature range between 600° C. and 450° C. at least for a period of time of cooling period t_{MT}. Within this temperature range, there is on the one hand a significant diffusion rate of iron into aluminum, and on the other hand the diffusion of aluminum into steel is inhibited since the temperature is below half the melting temperature of steel. This enables diffusion of iron into the anticorrosion coating without significant diffusion of aluminum into the steel substrate.

The diffusion of iron into the anticorrosion coating has several advantages.

Firstly, the melting of the anticorrosion coating is delayed on austenitization prior to press hardening. Secondly, there is homogenization of the coefficients of thermal expansion of anticorrosion coating and substrate. This means that the transition region between the coefficients of thermal expansion of substrate and surface becomes broader, which reduces thermal stresses on reheating.

At the same time, the diffusion of aluminum into the steel substrate would have considerable disadvantages. By virtue of the very high affinity of aluminum for nitrogen, a high aluminum content can have the effect that nitrogen is removed from fine precipitates, such as vanadium carbonitrides, niobium carbonitrides or titanium carbonitrides, and there is instead preferential formation of coarse precipitates, such as aluminum nitrides, at the grain boundaries. This would worsen crash performance, and also reduce the bending angle. Moreover, this destabilizes the fine precipitates (for example the V-containing or Nb-containing precipitates) in the uppermost substrate region, which are important for many preferred properties. In addition, the inhomogeneous diffusion rate of aluminum in the steel substrate into ferrite compared to pearlite/bainite/martensite would lead to an inhomogeneous distribution of Al in the edge layer of the steel substrate. This should likewise be avoided in order to improve crash performance and bending performance. These disadvantages of the diffusion of aluminum into the steel substrate are therefore reduced or avoided by inhibition.

By virtue of the preferred first cooling time t_{MT} (14 s), there is an increase in the iron concentration in the interfacial transition layer to such an extent that this further reduces the activity of aluminum in the coating directly at the substrate boundary. This then leads to an even further decrease in aluminum uptake into the substrate on austenitization prior to the press hardening with the associated advantages described above.

The second cooling period t_{LT} in the temperature range between 400° C. and 300° C. (low temperature range LT) can likewise be implemented by gradual, continuous cooling or else by holding at a temperature for a certain time within this temperature range. Intermediate heating is even possible. All that is important is that the flat steel product remains within the temperature range between 400° C. and 300° C. at least for a period of time of cooling period t_{LT}.

Within this temperature range, there is still a certain diffusion rate of carbon within the steel substrate, while thermodynamic solubility is very low. Carbon thus diffuses to and collects at lattice defects, for example dissolved V or Nb atoms. These widen the atomic lattice by virtue of their much higher atomic volume and hence increase the size of the tetrahedra and octahedral gaps in the atomic lattice, such that the local solubility of C is increased. This results in clusters of C and V and/or Nb, which are then transformed to very fine precipitates in the austenitization step and/or transfer step of the hot forming. These lead firstly to a refined austenite structure, and secondly constitute hydrogen traps that lead to a reduction in the free hydrogen content.

In the case of the preferred hold time of more than 12 s, very fine iron carbides (called transition carbides) are additionally formed, which in turn dissolve very quickly on austenitization and lead to additional austenite grains and hence to an even finer austenite structure and hence also hardening structure.

The coated flat steel product can optionally be subjected to a skin pass rolling operation with a degree of skin pass rolling of up to 2%, in order to improve the surface roughness of the flat steel product.

The invention further relates to a shaped sheet metal part formed from a flat steel product comprising an above-elucidated steel substrate.

In particular, the shaped sheet metal part additionally comprises an anticorrosion coating. The anticorrosion coating has the advantage of preventing scale formation during austenitization in the hot forming operation. In addition, such an anticorrosion coating protects the formed shaped sheet metal part against corrosion.

In a specific embodiment, the shaped sheet metal part preferably comprises an aluminum-based anticorrosion coating. The anticorrosion coating of the shaped sheet metal part preferably comprises an alloy layer and an Al base layer. In the shaped sheet metal part, the alloy layer is also frequently referred to as interdiffusion layer.

The thickness of the anticorrosion coating is preferably at least 10 μm, more preferably at least 20 μm, especially at least 30 μm.

The thickness of the alloy layer is preferably less than 30 μm, more preferably less than 20 μm, especially less than 16 μm, more preferably less than 12 μm. The thickness of the Al base layer is found from the difference in the thicknesses of anticorrosion coating and alloy layer.

The alloy layer here lies atop and directly adjoins the steel substrate. The alloy layer of the shaped sheet metal part preferably consists of 35-90% by weight of Fe, 0.1-10% by weight of Si, optionally up to 0.5% by weight of Mg and optional further constituents, the contents of which are limited to a total of not more than 2.0% by weight, and aluminum as the balance. As a result of the further diffusion of iron into the alloy layer, the proportions of Si and Mg are correspondingly lower than the respective proportion thereof in the melt in the melt bath.

The alloy layer preferably has a ferritic structure.

The Al base layer of the shaped sheet metal part lies atop and directly adjoins the alloy layer of the steel component. The Al base layer of the steel component preferably consists of 35-55% by weight of Fe, 0.4-10% by weight of Si, optionally up to 0.5% by weight of Mg and optional further constituents, the contents of which are limited to a total of not more than 2.0% by weight, and aluminum as the balance.

The Al base layer may have a homogeneous element distribution in which the local element contents vary by not more than 10%. Preferred variants of the Al base layer, by contrast, have low-silicon phases and silicon-rich phases. Low-silicon phases here are regions wherein the average Si content is at least 20% less than the average Si content of the Al base layer. Silicon-rich phases here are regions wherein the average Si content is at least 20% more than the average Si content of the Al base layer.

In a preferred variant, the silicon-rich phases are disposed within the low-silicon phase. In particular, the silicon-rich phases form at least a 40% continuous layer bounded by low-silicon regions. In an alternative execution variant, the silicon-rich phases are arranged in insular form in the low-silicon phase.

What is meant by “in insular form” in the context of this application is an arrangement in which discrete noncoherent regions are surrounded by another material-i.e. there are “islands” of a particular material in another material.

In a preferred variant, the steel component comprises an oxide layer disposed atop the anticorrosion coating. The oxide layer lies in particular atop the Al base layer and preferably forms the outer conclusion of the anticorrosion coating.

The oxide layer of the steel component consists especially to an extent of more than 80% by weight of oxides, where the majority of the oxides (i.e. more than 50% by weight of the oxides) is aluminum oxide. The oxide layer optionally includes, in addition to aluminum oxide, hydroxides and/or magnesium oxide alone or as a mixture. The remainder of the oxide layer not accounted for by the oxides and optionally present hydroxides preferably consists of silicon, aluminum, iron and/or magnesium in metallic form.

The oxide layer preferably has a thickness of at least 50 nm, especially of at least 100 nm. In addition, the thickness is not more than 4 μm, especially not more than 2 μm.

In a specific configuration, the shaped sheet metal part comprises a zinc-based anticorrosion coating.

Such a zinc-based anticorrosion coating preferably comprises preferably up to 80% by weight of Fe, 0.2-6.0% by weight of Al, 0.1-10.0% by weight of Mg, optionally 0.1-40% by weight of manganese or copper, optionally 0.1-10.0% by weight of cerium, optionally not more than 0.2% by weight of further elements, unavoidable impurities, and zinc as the balance. In particular, the Al content is not more than 2.0% by weight, preferably not more than 1.5% by weight. The Fe content that arises from inward diffusion is preferably more than 20% by weight, especially more than 30% by weight. In addition, the Fe content is especially not more than 70% by weight, especially not more than 60% by weight. The Mg content is especially not more than 3.0% by weight, preferably not more than 1.0% by weight. The anticorrosion coating may be applied by hot dip coating or by physical gas phase deposition or by electrolytic methods.

In a specific development, the steel substrate of the shaped sheet metal part has a structure having more than 80% martensite and/or lower bainite at least in part, preferably more than 90% martensite and/or lower bainite at least in part, especially more than 95% martensite and/or lower bainite at least in part, more preferably more than 98% martensite and/or lower bainite at least in part. What is meant by “martensite and/or lower bainite” is that the respective structure component consists of martensite or lower bainite or a mixture of martensite and/or lower bainite. In an even more specific development, the steel substrate of the shaped sheet metal part has a structure having more than 80% martensite at least in part, preferably more than 90% martensite at least in part, especially more than 95% at least in part, more preferably more than 98% at least in part. What is meant in this context by “partly having” or “having . . . in part” is that there are regions of the shaped sheet metal part that have the structure mentioned. In addition, there may also be regions of the shaped sheet metal part that have a different structure. The shaped sheet metal part thus has the structure mentioned in sections or regions.

By virtue of the high martensite content or lower bainite content, it is possible to achieve very high tensile strengths and yield points.

The shaped sheet metal part in a developed variant at least partly has a yield point of at least 950 MPa, especially at least 1100 MPa, especially at least 1200 MPa, preferably at least 1300 MPa, preferably at least 1400 MPa.

In a developed variant, the shaped sheet metal part at least partly has a tensile strength of at least 1000 MPa, especially at least 1100 MPa, preferably at least 1300 MPa, preferably at least 1400 MPa, especially at least 1600 MPa, preferably at least 1700 MPa, especially at least 1800 MPa.

In particular, the shaped sheet metal part at least partly has an elongation at break A50 of at least 3.5%, especially at least 4%, especially at least 4.5%, preferably at least 5%, more preferably at least 6%, especially at least 6.5%.

In addition, the shaped sheet metal part, in a preferred variant, may at least partly have a bending angle of at least 30°, especially at least 40°, especially at least 45°, preferably at least 47°, especially at least 48°, more preferably at least 49°.

The bending angle depends specifically on the position of the bending axis. Typically, a distinction is made between the bending angle transverse to rolling direction (i.e. bending axis at right angles to rolling direction) and bending angle longitudinally with rolling direction (i.e. bending axis parallel to rolling direction). If a shaped sheet metal part has a particular bending angle (for example of at least 45°), what this means in the context of this application is that both bending angles (both parallel and at right angles to the rolling direction) satisfy the corresponding relation. In other words, for example, both are at least 45°.

What is meant in this context by “partly having” or “having . . . in part” is that there are regions of the shaped sheet metal part that have the mechanical property mentioned. In addition, there may also be regions of the shaped sheet metal part where the mechanical property is below the limit. The shaped sheet metal part thus has the mechanical property mentioned in sections or regions. This is because different regions of the shaped sheet metal part can undergo different heat treatments. For example, individual regions can be cooled more quickly than others, as a result of which more martensite, for example, is formed in the more rapidly cooled regions. Therefore, different mechanical properties are also established in the different regions.

The mechanical indices mentioned have been found to be particularly advantageous in order to assure use in an automobile with good crash performance.

In a specific development, the shaped sheet metal part has fine precipitates in the structure, especially in the form of vanadium carbonitrides, niobium carbonitrides and/or titanium carbonitrides.

Fine precipitates in the context of this application refer to all precipitates having a diameter of less than 30 nm. The other precipitates are referred to as coarse precipitates.

In a preferred configuration, the average diameter of the fine precipitates is not more than 11 nm, preferably not more than 10 nm, especially not more than 8 nm, preferably not more than 6 nm.

In a further preferred configuration, the shaped sheet metal part has largely fine precipitates in the structure. In the context of this application, what is meant by largely fine precipitates is that more than 80%, preferably more than 90%, of all precipitates are fine precipitates. This means that more than 80%, preferably more than 90%, of all precipitates have a diameter of less than 30 nm.

The fine precipitates result in a particularly fine structure having small grain diameters. The fine structure is more homogeneous as a result. An improvement in mechanical properties is found, in particular lower crack sensitivity and hence improved bending properties and higher elongation at break. This also results in better toughness with more marked necking characteristics on fracture.

The real mechanical indices of this shaped sheet metal part are ascertained by first subjecting the shaped sheet metal part to cathodic coating with dip-coating lacquer or an analogous heat treatment. Cathodic electrocoating operations are generally conducted for corresponding components in the automotive industry. In cathodic dip coating, the components are first coated in an aqueous solution. This coating is then baked in a heat treatment. This involves heating the shaped sheet metal parts to 170° C. and keeping them at that temperature for 20 minutes. Subsequently, the components are cooled down to room temperature under ambient air. Since this heat treatment can influence mechanical indices, the mechanical indices (yield point, tensile strength, yield point ratio, elongation at break A50, bending angle, Vickers hardness) in the context of this application should be regarded as existing in a component with a cathodic dip coating or in a component which, after forming, has been subjected to a heat treatment which is analogous to a cathodic dip coating. In practice, the heat treatment of the cathodic dip coating varies slightly. Customary temperatures are 165° C.-180° C. and hold times 12-30 minutes. However, the change in the mechanical indices because of these variations (165° C.-180° C.; 12-30 minutes) are negligible in the subsequent heat treatment.

In a preferred variant, the shaped sheet metal part comprises a cathodic dip coating.

It is a feature of a developed variant of the shaped sheet metal part that the anticorrosion coating is an aluminum-based anticorrosion coating and the shaped sheet metal part comprises an alloy layer and an Al base layer.

In a preferred execution variant, the shaped sheet metal part has a breaking stress in the modified slow strain rate test of greater than 610 MPa, especially greater than 625 MPa. This test ensures that the preferred execution variant is less sensitive to hydrogen. In the practical use of the shaped sheet metal part, the effect of this is that the risk of hydrogen embrittlement is reduced.

The shaped sheet metal part of the invention is preferably a component for a land vehicle, nautical vessel or aircraft. It is more preferably an automobile component, especially a bodywork component. The component is preferably a B pillar, longitudinal beam, A pillar, sill or transverse beam.

In the process of the invention for production of an inventive shaped sheet metal part of the type as elucidated above, at least the following steps are performed:
a) providing a sheet metal blank made from an above-described flat steel product, especially a flat steel product comprising a steel substrate composed of steel consisting of, as well as iron and unavoidable impurities, (in % by weight)

$$C : 0.06 - 0.5 \% ,$$

$$Si : 0.05 - 0.6 \% ,$$

$$Mn : 0.4 - 3. \% ,$$

$$Al : 0.06 - 1. \% ,$$

$$B : 0.0005 - 0.01 \% ,$$

$$V : 0.01 - 0.5 \% ,$$

$$P : \leq 0.03 \% ,$$

$$S : \leq 0.02 \% ,$$

$$N : \leq 0.02 \% ,$$

$$Sn : \leq 0.03 \% ,$$

$$As : \leq 0.01 \%$$

and optionally one or more of the elements “Ce, La, Nb, Cr, Cu, Mo, Ni, Ca, W” in the following contents:

$$Ce + La : 0.01 - 0.03 \% ,$$

$$Ti : 0.0005 - 0.1 \% ,$$

$$Nb : 0.001 - 0.2 \% ,$$

$$Cr : 0.01 - 1. \% ,$$

$$Cu : 0.01 - 0.2 \% ,$$

$$Mo : 0.002 - 0.3 \% ,$$

$$Ni : 0.01 - 0.5 \% ,$$

$$Ca : 0.0005 - 0.005 \% ,$$

$$W : 0.001 - 1. \% ,$$

$$or of$$

$$C : 0.06 - 0.5 \% ,$$

$$Si : 0.05 - 0.6 \% ,$$

$$Mn : 0.4 - 3. \% ,$$

$$B : 0.0005 - 0.01 \% ,$$

$$V : 0.01 - 0.5 \% ,$$

$$P : \leq 0.03 \% ,$$

$$S : \leq 0.02 \% ,$$

$$N : \leq 0.02 \% ,$$

$$Sn : \leq 0.03 \% ,$$

$$As : \leq 0.01 \% ,$$

$$Ce + La : 0.01 - 0.03 \% ,$$

and optionally one or more of the elements “Al, Nb, Cr, Cu, Mo, Ni, Ca, W” in the following contents:

$$Al : \leq 1. \% ,$$

$$Ti : 0.0005 - 0.1 \% ,$$

$$Nb : 0.001 - 0.2 \% ,$$

$$Cr : 0.01 - 1. \% ,$$

$$Cu : 0.01 - 0.2 \% ,$$

$$Mo : 0.002 - 0.3 \% ,$$

$$Ni : 0.01 - 0.5 \% ,$$

$$Ca : 0.0005 - 0.005 \% ,$$

$$W : 0.001 - 1. \% ;$$

b) heating the sheet metal blank such that the AC3 temperature of the blank is exceeded at least to some degree and the temperature Tᵢₙₛ of the blank on insertion into a forming tool provided for a hot press forming operation (step c)) is at least partly at a temperature above Ms+100° C., especially above Ms+300° C., where Ms denotes the martensite start temperature;
c) inserting the heated sheet metal blank into a forming tool, where the transfer time tₜᵣₐₙₛ required for the removal from the heating device and the insertion of the blank is not more than 20 s, preferably not more than 15 s;
d) hot press forming the sheet metal blank to give the shaped sheet metal part, where the blank in the course of hot press forming is cooled to the target temper-ature T_{target} over a period tₜₒₒₗ of more than 1 s at a cooling rate rₜₒₒₗ of at least partly more than 30 K/s and optionally held at that temperature;
e) removing the shaped sheet metal part that has been cooled to target temperature from the tool.

In the process of the invention, a blank consisting of a steel of suitable composition in accordance with the elucidations above is thus provided (step a)) and is then heated in a manner known per se such that the AC3 temperature of the blank is exceeded at least in part and the temperature Tᵢₙₛ of the blank on insertion into a forming tool provided for a hot press forming operation (step c)) is at least partly at a temperature above Ms+100° C., especially above Ms+300° C. In particular, the temperature Tᵢₙₛ of the blank on insertion is at least partly 600° C. In a particularly preferred variant, the temperature Tᵢₙₛ of the blank on insertion is at least partly, especially completely, within a range of 600° C. to 850° C., in order to assure good formability and sufficient hardenability. What is meant in the context of this application by “partial exceedance of a temperature” (here, AC3 or Ms+100° C.) is that at least 30%, especially at least 60%, of the volume of the blank, preferably the whole blank, exceeds a corresponding temperature. The same applies to the at least partial existence of a temperature in the interval of 600° C. to 850° C. in the preferred variant elucidated above. On insertion into the forming tool, at least 30% of the blank thus has an austenitic structure, meaning that the transformation from the ferritic to austenitic structure need not be complete on insertion into the forming tool. Instead, up to 70% of the volume of the blank on insertion into the forming tool may consist of other structure constituents, such as annealed bainite, annealed martensite and/or non-recrystallized or partly recrystallized ferrite. For this purpose, particular regions of the blank may be specifically kept at a lower temperature level during the heating than others. For this purpose, the supply of heat may be directed specifically only to particular sections of the blank, or the parts that are to be heated to a lesser degree may be shielded against the supply of heat. In the part of the blank material wherein the temperature remains lower, only a distinctly smaller amount of martensite or lower bainite, if any, is formed in the course of forming in the tool, such that the structure there is much softer than in the respective other parts in which there is a martensitic structure (or a structure comprising lower bainite). In this way, in the respectively formed shaped sheet metal part, it is possible to specifically establish a softer region in which, for example, toughness is optimal for the respective end use, while the other regions of the shaped sheet metal part have maximized strength.

Maximum strength properties of the resultant shaped sheet metal part may be enabled in that the temperature attained at least to some degree in the sheet metal blank is between Ac3 and 1000° C., preferably between 850° C. and 950° C.

The minimum temperature Ac3 to be exceeded is determined by the following formula specified by HOUGARDY, HP. in Werkstoffkunde Stahl, Band 1: Grundlagen [Materials; Steel; Volume 1: Principles], Verlag Stahleisen GmbH, Düsseldorf, 1984, p. 229:

$$AC 3 [ ° C . ] = ( 902 \% by wt . - {225}^{*} \% C + {19}^{*} \% Si - {11}^{*} \% Mn - {5}^{*} \% Cr + {13}^{*} \% Mo - {20}^{*} \% Ni + {55}^{*} \% V ) [ ° C . / \% by wt . ]$$

with % C=respective C content, % Si=respective Si content, % Mn=respective Mn content, % Cr=respective Cr content, % Mo=respective Mo content, % Ni=respective Ni content and % V=respective V content of the steel of which the blank consists.

An optimally uniform distribution of properties can be achieved in that the blank is fully through-heated in step b).

In a preferred execution variant, the average heating rate r_{furnace} of the sheet metal blank on heating in step b) is at least 3 K/s, preferably at least 5 K/s, especially at least 6 K/s, preferably at least 8 K/s, especially at least 10 K/s, preferably at least 15 K/s. The average heating rate r_{furnace} here is the average heating rate from 30° C. to 700° C.

In a preferred execution variant, the normalized average heating Θₙₒᵣₘ is at least 5 Kmm/s, especially at least 8 Kmm/s, preferably at least 10 Kmm/s. At maximum, the normalized average heating is 15 Kmm/s, especially at most 14 Kmm/s, preferably at most 13 Kmm/s.

Average heating Θ means the product of average heating rate in kelvin per second from 30° C. to 700° C. and sheet thickness in millimeters.

For normalized average heating, this product Θ is normalized by the current furnace temperature T_{furnace} relative to a reference furnace temperature T_{furnace, reference} of 900° C.=1173.15 K in the following manner:

$${Θ}_{norm} = \frac{{T}_{furnace , reference}^{4}}{{T}_{furnace}^{4}} \cdot Θ$$

where the furnace temperatures should in each case be inserted in kelvin.

In a preferred execution variant, the heating is effected in a furnace having a furnace temperature T_{furnace} of at least Ac3+10 C, preferably at least 850° C., preferably at least 880° C., more preferably at least 900° C., especially at least 920° C., and not more than 1000° C., preferably not more than 950° C., more preferably not more than 930° C.

Preferably, the dewpoint of the furnace atmosphere in the furnace here is at least −20° C., preferably at least −15° C., especially at least −5° C., more preferably at least 0° C., and not more than +25° C., preferably not more than +20° C., especially not more than +15° C.

In a specific execution variant, the heating in step b) is effected stepwise in regions with different temperature. In particular, the heating is effected in a roller hearth furnace with different heating zones. The heating is effected here in a first heating zone with a temperature (called the furnace entry temperature) of at least 650° C., preferably at least 680° C., especially at least 720° C. The temperature in the first heating zone is preferably not more than 900° C., especially not more than 850° C. Further preferably, the maximum temperature of all heating zones in the furnace is not more than 1200° C., especially not more than 1000° C., preferably not more than 950° C., more preferably not more than 930° C.

The total time in the furnace t_{furnace}, composed of a heating time and a hold time, in both variants (constant furnace temperature, stepwise heating), is preferably at least 2 minutes, especially at least 3 minutes, preferably at least 4 minutes. In addition, the total time in the furnace in both variants is preferably not more than 20 minutes, especially not more than 15 minutes, preferably not more than 12 minutes, especially not more than 8 minutes. Prolonged total times in the furnace have the advantage that uniform austenitization of the sheet metal blank is assured. On the other hand, holding above Ac3 for an excessively long period leads to grain coarsening, which has an adverse effect on mechanical properties.

The blank which has thus been heated is removed from the respective heating device, which may, for example, be a conventional heating furnace, an induction heating device which is likewise known per se, or a conventional device for keeping steel components hot, and transported into the forming tool with sufficient speed that its temperature on arrival in the tool is at least partly above Ms+100° C., especially above Ms+300° C., preferably above 600° C., especially above 650° C., more preferably above 700° C. Ms here denotes the martensite start temperature. In a particularly preferred variant, the temperature is at least partly above the AC1 temperature. In all these variants, the temperature is especially not more than 900° C. These temperature ranges assure good formability of the material overall.

In step c), the transfer of the austenitized blank from the respectively used heating device to the forming tool is performed within preferably not more than 20 s, especially not more than 15 s. Such rapid transport is required in order to avoid excessive cooling prior to forming.

The tool on insertion of the blank is typically at a temperature between room temperature (RT) and 200° C., preferably between 20° C. and 180° C., especially between 50° C. and 150° C. The tool on insertion of the blank may also have a temperature slightly below room temperature if, for example, the cooling water used is slightly colder (e.g. 15° C.). This means that the tool in individual execution variants has a temperature between 10° C. and 200° C. on insertion of the blank. In a particular embodiment, the tool may be adjusted at least in regions to a temperature Tₜₒₒₗ of at least 200° C., especially at least 300° C., in order to only partially harden the component. In addition, the tool temperature Tₜₒₒₗ is preferably not more than 600° C., especially not more than 550° C. It merely has to be ensured that the tool temperature Tₜₒₒₗ is below the desired target temperature T_{target}. The dwell time in the tool tₜₒₒₗ is preferably at least 2 s, especially at least 3 s, more preferably at least 5 s. The dwell time in the tool is preferably not more than 25 s, especially not more than 20 s, preferably not more than 10 s.

The target temperature T_{target} of the shaped sheet metal part is at least to some degree below 400° C., preferably below 300° C., especially below 250° C., preferably below 200° C., more preferably below 180° C., especially below 150° C. Alternatively, the target temperature T_{target} of the shaped sheet metal part is more preferably below Ms−50° C., where Ms denotes the martensite start temperature. In addition, the target temperature of the shaped sheet metal part is preferably at least 20° C., more preferably at least 50° C.

The martensite start temperature of a steel within the provisions of the invention should be calculated by the formula:

$$Ms [ ° C . ] = ( 490.85 \% by wt . - 302. \% C - 30.6 \% Mn - 16.6 \% Ni - 8.9 \% Cr + 2.4 \% Mo - 11.3 \% Cu + 8.58 \% Co + 7.4 \% W - 14.5 \% Si ) [ ° C . / \% by wt . ]$$

where C % here denotes the C content, % Mn the Mn content, % Mo the Mo content, % Cr the Cr content, % Ni the Ni content, % Cu the Cu content, % Co the Co content, % W the W content and % Si the Si content of the respective steel in % by weight.

The AC1 temperature and the AC3 temperature of a steel within the provisions of the invention should be calculated by the formulae:

$$AC 1 [ ° C . ] = ( 739 \% by wt . - {22}^{*} \% C - {7}^{*} \% Mn + {2}^{*} \% Si + {14}^{*} \% Cr + {13}^{*} \% Mo - {13}^{*} \% Ni + {20}^{*} \% V ) [ ° C . / \% by wt . ]$$

$$AC 3 [ ° C . ] = ( 902 \% by wt . - {225}^{*} \% C + {19}^{*} \% Si - {11}^{*} \% Mn - {5}^{*} \% Cr + {13}^{*} \% Mo - {20}^{*} \% Ni + {55}^{*} \% V ) [ ° C . / \% by wt . ]$$

where, here too, % C denotes the C content, % Si the Si content, % Mn the Mn content, % Cr the Cr content, % Mo the Mo content, % Ni the Ni content and +% V the vanadium content of the respective steel (Brandis H 1975 TEW-Techn. Ber. 1 8-10).

In the tool, the blank is thus not just shaped to give the shaped sheet metal part, but simultaneously also quenched to the target temperature. The cooling rate in the tool rₜₒₒₗ to the target temperature is especially at least 20 K/s, preferably at least 30 K/s, especially at least 50 K/s, in a particular execution at least 100 K/s.

The removal of the shaped sheet metal part in step e) is followed by cooling of the shaped sheet metal part to a cooling temperature T_{AB} of less than 100° C. within a cooling period t_{AB} of 0.5 to 600 s. This is generally accomplished by air cooling.

In a preferred execution variant, the flat steel product and the process for producing a shaped sheet metal part are developed such that the flat steel product has regions of different thickness. The shaped sheet metal part is likewise developed such that it has regions of different thickness.

Regions of different thickness of the flat steel product (called “tailored blanks”) may be created in various ways:
Special cold rolling passes in which individual regions are more intensely or frequently rolled (for example up to degrees of rolling of 50%) result in a lower material thickness in these regions and hence a lower thickness (called “tailor rolled blanks”).
By welding (typically by laser welding), sheet metal blanks of different thickness are bonded to one another in order to achieve a coherent sheet metal blank having regions of different thickness (called “tailor welded blanks”).
By resistance spot welding or laser welding, patches are applied to an existing sheet metal blank in order to thicken regions thereof. Alternatively, the patches may also be applied by means of structural adhesives.

By the processes described for production of a shaped sheet metal part, the flat steel product having regions of different thickness results in a shaped sheet metal part having regions of different thickness.

Regions of different thickness have the advantage that individual areas of the final shaped sheet metal part can be specifically strengthened. In this way, it is possible to give those parts that are subject to exceptional stresses (for example during a crash) a correspondingly stable configuration, whereas other parts have a thinner configuration in order to reduce the weight of the component. The result is thus a weight-optimized component that has specific strengthening in the regions of high stresses.

In a preferred execution variant, the flat steel product and the process for producing a shaped sheet metal part are developed such that the flat steel product has regions of different material. The shaped sheet metal part is likewise developed such that it has regions of different material.

By welding (typically by laser welding), sheet metal blanks made of different material can also be bonded to one another in order to achieve a coherent shaped sheet metal part having regions of different strength. This too is frequently covered by the umbrella term “tailor welded blanks”. This achieves the effect that there are parts of the shaped sheet metal part having good formability and relatively low strength, and simultaneously other parts having high strength.

The aforementioned options for locally individual adjustment of properties of the shaped sheet metal part may of course also be combined.

In a preferred execution variant, the shaped sheet metal part produced may be used, for example, in its entirety or as part of a shaped sheet metal part in automobile construction, for example as a B pillar, A pillar, sill, roof frame, bumper beam, door reinforcement, underbody protection of the battery cell etc.

The invention is elucidated in detail by working examples.

FIG. 1 shows the sample geometry in the measurement of resistance to hydrogen embrittlement by means of the modified slow strain rate test.

The effect of the invention was shown by conducting multiple experiments. For this purpose, slabs having the compositions specified in table 1 were produced with a thickness of 200-280 mm and width of 1000-1200 mm, heated up to a respective temperature T1 in a pusher furnace and kept at T1 for between 30 and 450 min until the temperature T1 had been attained in the core of the slabs and hence the slabs were through-heated. The production parameters are reported in table 2. The slabs with their respective through-heating temperature T1 were discharged from the pusher furnace and subjected to hot rolling. The experiments were performed in the form of a continuous hot strip rolling operation. For this purpose, the slabs were first pre-rolled to an intermediate product of thickness 40 mm, and the intermediate products, which can also be referred to as preliminary strips in the hot strip operation, each had an intermediate product temperature T2 at the end of the preliminary rolling phase. Immediately after preliminary rolling, the preliminary strips were sent to finish rolling, such that the intermediate product temperature T2 corresponds to the initial rolling temperature for the finish rolling phase. The preliminary strips were rolled out to hot strips having a final thickness of 3-7 mm and the respective final rolling temperatures T3 specified in table 2, cooled down to the respective coiling temperature and wound up to coils at the respective coiling temperatures T4 and then cooled under stationary air. The hot strips were descaled by pickling in a conventional manner, before being subjected to cold rolling with the degrees of cold rolling specified in table 2. The cold-rolled flat steel products were heated in a tunnel annealing furnace to a respective annealing temperature T5 and kept at annealing temperature for 100 s in each case, before being cooled down to their respective dipping temperature T6 at a cooling rate of 1 K/s. The cold strips with their respective dipping temperature T6 were conducted through a molten coating bath at temperature T7. The composition of the coating bath is reported in table 3. After the coating operation, the coated strips were blown in a conventional manner, producing a specific layer thickness (see table 3). The strips were first cooled down to 600° C. at an average cooling rate of 10-15 K/s. In the course of further cooling between 600° C. and 450° C. and between 400° C. and 300° C., the strips were cooled down over the cooling periods T_{MT} and T_{LT} specified in table 2. Between 450° C. and 400° C. and below 220° C., the strips were cooled down at a cooling rate of 5-15 K/s in each case.

Table 4 is a collation of which steel variant (see table 1) was combined with which process variant (see table 2) and which coating (see table 3).

Steel compositions 1 are a reference example not in accordance with the invention. Correspondingly, experiments 1 and 5 are not in accordance with the invention.

The thickness of the steel strips produced was 1.5 mm in all experiments.

After cooling to room temperature, samples were taken transverse to the rolling direction from the cooled steel strips according to DIN EN ISO 6892-1 sample form 2 (Annex B Tab. B1). The samples were subjected to a tensile test in accordance with DIN EN ISO 6892-1 sample form 2 (Annex B Tab. B1). Table 4 gives the results of the tensile test. In the course of the tensile test, the following material indices were ascertained: the type of yield point, which is identified by Re for a pronounced yield point and by Rp for a continuous yield point, and in the case of a continuous yield point the value for the yield point Rp0.2, in the case of a pronounced yield point the values for the lower yield point ReL, the upper yield point ReH and the difference between upper and lower yield points ΔRe and the tensile strength Rm. All samples have a continuous yield point Rp or an only slightly pronounced yield point having a difference ΔRe between upper and lower yield points of not more than 50 MPa. There is a continuous yield point for the samples 6, and a pronounced yield point for all other samples. The yield point Rp0.2 is therefore reported for sample 6. For all other samples, upper and lower yield points are reported.

Blanks have been divided from each of the 8 steel strips thus produced, which were used for the further experiments. In these experiments, shaped sheet metal part samples 1-8 in the form of sheets of size 194×400 mm2 have been hot press formed from the respective blanks to give components in profile form. For this purpose, the blanks have been heated in a heating device, for example in a conventional heating furnace, from room temperature at an average heating rate rfurnace (between 30° C. and 700° C.) in a furnace with a furnace temperature T_{furnace}. The total duration in the furnace, comprising heating and holding, is designated t_{furnace}. The dewpoint of the furnace atmosphere in all cases was −5° C. Subsequently, the blanks have been removed from the heating device and inserted into a forming tool at temperature Tₜₒₒₗ. At the time of removal from the furnace, the blanks had assumed the furnace temperature. The transfer duration tₜᵣₐₙₛ composed of the duration for the removal from the heating device, transport to the tool and insertion into the tool was between 5 and 14 s. The temperature Tᵢₙₛ of the blanks on insertion into the forming tool in all cases was above the respective martensite start temperature +100° C. The blanks have been formed in the forming tool to the respective shaped sheet metal part, with cooling of the shaped sheet metal parts in the tool at a cooling rate rₜₒₒₗ. The dwell time in the tool is designated tₜₒₒₗ. Finally, the samples have been cooled to room temperature under air. Table 5 is a collation of these parameters, where “RT” is an abbreviation of room temperature.

The parameters used here for the forming process lead to virtually complete formation of martensitic structure.

Table 6 is a compilation of the overall results for the shaped sheet metal parts obtained. The first columns indicate the sample number, the steel type according to table 1, the process variant according to table 2, the coating according to table 3 and the hot forming variant according to table 5. The further columns give the yield point Rp, tensile strength Rm, and elongation at break A50. These values were ascertained in accordance with DIN EN ISO 6892-1 sample form 2 (Annex B Tab. B1) on samples that were taken transverse to the rolling direction on the flat surfaces of the components in profile form. In addition, bending angle, in accordance with VDA standard 238-100, is reported both transverse and longitudinally to rolling direction. The bending angle ascertained here is calculated by the formula specified in the standard from the path of the ram (the bending angle ascertained (also referred to as maximum bending angle) is the bending angle at which the force has its maximum in the bending experiment).

All mechanical indices in table 6 were ascertained using samples that had been cut out of the planar parts of the formed hat profile. In addition, the mechanical indices in table 6were ascertained (except for breaking stress in the modified slow strain rate test) after a cathodic electrocoat had been applied to the formed shaped sheet metal part. During this coating process, the shaped sheet metal parts were heated to 170° C. and kept at that temperature for 20 minutes. Subsequently, the shaped sheet metal parts are cooled down to room temperature under ambient air.

Breaking stress in the modified slow strain rate test was ascertained without any such cathodic electrocoating and without analogous heat treatment.

As well as the mechanical properties, in addition, the structure was determined and was fully martensitic in all cases (i.e. more than 99% martensite). In addition, for samples 5, 6 and 8, the precipitates in the structure were determined in the form of vanadium carbonitrides, niobium carbonitrides and/or titanium carbonitrides. The precipitates are determined with the aid of electron images and x-ray images (TEM and EDX) using carbon extraction replicas. The carbon extraction replicas were produced using longitudinal sections (20×30 mm). The measurement had a resolution of between 10 000-fold and 200 000-fold. These images can be used to divide the precipitates into coarse and fine precipitates. Fine precipitates refer to all precipitates having a diameter of less than 30 nm. The other precipitates are referred to as coarse precipitates. By simple counting, the proportion of fine precipitates in the total number of precipitates in the measurement field is ascertained. For the fine precipitates, in addition, the average diameter is calculated by computer-assisted image analysis. For all three samples examined, the proportion of fine precipitates is more than 90%. The average diameter of the fine precipitates for sample 5 was 5 nm, for sample 6 the average diameter was 14 nm, and for sample 8 the average diameter was 4.5 nm.

TABLE 1
(steel types)

| Steel | C | Si | Mn | Al | Cr | Nb | Ti | B | P | S | N |
|---|---|---|---|---|---|---|---|---|---|---|---|
| A* | 0.311 | 0.15 | 1.07 | 0.18 | 0.15 | 0.027 | 0.012 | 0.0018 | 0.005 | 0.003 | 0.0012 |
| B | 0.315 | 0.16 | 1.11 | 0.20 | 0.16 | <0.0005 | 0.012 | 0.0025 | 0.006 | <0.001 | 0.0018 |
| C | 0.312 | 0.16 | 1.10 | 0.20 | 0.16 | 0.021 | 0.001 | 0.0023 | 0.005 | 0.002 | 0.0019 |
| D | 0.318 | 0.15 | 1.11 | 0.20 | 0.16 | 0.021 | 0.001 | 0.0023 | 0.005 | <0.001 | 0.0016 |

| Steel | Sn | As | Ca | Cu | Mo | Ni | V | Ce + La |
|---|---|---|---|---|---|---|---|---|
| A* | ≤0.03 | ≤0.01 | ≤0.0005 | 0.005 | <0.001 | 0.015 | <0.001 | <0.001 |
| B | ≤0.03 | ≤0.01 | ≤0.0005 | 0.009 | 0.0021 | 0.020 | 0.150 | 0.0215 |
| C | ≤0.03 | ≤0.01 | ≤0.0005 | 0.007 | 0.0015 | 0.017 | 0.053 | <0.001 |
| D | ≤0.03 | ≤0.01 | ≤0.0005 | 0.007 | 0.0016 | 0.018 | 0.054 | 0.0237 |

balance: iron and unavoidable impurities figures each in % by weight;
*noninventive reference examples
fmoly

TABLE 2
(production conditions for flat steel product)

| Process | T1 | T2 | T3 | T4 | DCR | T5 | T6 | T7 | t_{MT} | t_{LT} |
|---|---|---|---|---|---|---|---|---|---|---|
| variant | [° C.] | [° C.] | [° C.] | [° C.] | [%] | [° C.] | [° C.] | [° C.] | [s] | [s] |
| a | 1280 | 1075 | 860 | 500 | 42 | 775 | 680 | 670 | 15 | 15 |
| b | 1280 | 1075 | 860 | 620 | 42 | 775 | 680 | 670 | 15 | 15 |

Some figures rounded

TABLE 3
(coating variant)

| | | | | | | Layer |
|---|---|---|---|---|---|---|
| Coating | Melt analysis | | | | | thickness (on |
| variant | Si | Fe | Mg | Others | Al | one side) [μm] |
| α | 10.5 | 2.3 | 0.3 | <1% | Balance | 20 |

TABLE 4
(flat steel product)

| | | Thickness | | | Rp0.2 | | |
|---|---|---|---|---|---|---|---|
| Coating | | of the steel | Process | Yield point | or ReH | ReL | Rm |
| experiment no. | Steel | strip [mm] | variant | type | [MPa] | [MPa] | [MPa] |
| 1* | A | 1.5 | a | pronounced | 679 | 648 | 739 |
| 2 | B | 1.5 | a | pronounced | 752 | 706 | 801 |
| 3 | C | 1.5 | a | pronounced | 618 | 577 | 707 |
| 4 | D | 1.5 | a | pronounced | 639 | 599 | 718 |
| 5* | A | 1.5 | b | pronounced | 608 | 560 | 687 |
| 6 | B | 1.5 | b | continuous | 744 | — | 804 |
| 7 | C | 1.5 | b | pronounced | 622 | 582 | 719 |
| 8 | D | 1.5 | b | pronounced | 638 | 600 | 732 |

*noninventive reference examples

TABLE 5
(hot forming parameters)

| Hot | Average heating | | | | Furnace | | | | Cooling | |
|---|---|---|---|---|---|---|---|---|---|---|
| forming | rate r_{furnace} [30- | T_{furnace} | t_{furnace} | Transfer | dewpoint | Tᵢₙₛ | Tₜₒₒₗ | tₜₒₒₗ | rate rₜₒₒₗ | T_{target} |
| variant | 700° C.] [K/s] | [° C.] | [min.] | time [s] | [° C.] | [° C.] | [° C.] | [s] | [K/s] | [° C.] |
| I | 8.3 | 920 | 5 | 7 | −5 | 780 | RT | 13 | 49.2 | 140 |

Some figures rounded

TABLE 6
(shaped sheet metal part)

| | | | | | | | | | | Breaking |
|---|---|---|---|---|---|---|---|---|---|---|
| | | | | | | | | | | stress Rm in |
| | | | | | | | | Bending angle [°] | | the modified |
| Forming | | | | Hot | Yield | Tensile | | Bending | Bending | slow strain |
| experiment | | Process | Coating | forming | point | strength | A50 | axis | axis | rate test |
| No. | Steel | variant | variant | variant | [MPa] | [MPa] | [%] | transverse | longitudinal | [MPa] |
| 1* | A | a | α | I | 1428 | 1830 | 7.0 | 48.5 | 42.0 | 550 |
| 2 | B | a | α | I | n.d. | n.d. | n.d. | 47.3 | 45.9 | 635 |
| 3 | C | a | α | I | 1448 | 1865 | 6.8 | 48.0 | 47.0 | 519 |
| 4 | D | a | α | I | 1423 | 1832 | 6.8 | 47.7 | 48.0 | 639 |
| 5* | A | b | α | I | 1428 | 1810 | 6.4 | 51.3 | 43.5 | 612 |
| 6 | B | b | α | I | 1422 | 1810 | 6.7 | 54.4 | 48.3 | 660 |
| 7 | C | b | α | I | 1423 | 1836 | 6.5 | 48.8 | 50.8 | 551 |
| 8 | D | b | α | I | 1417 | 1814 | 6.8 | 49.2 | 50.9 | 765 |

n.d. = not determined
*noninventive reference examples

1-20. (canceled)

21. A flat steel product for hot forming, comprising a steel substrate composed of steel comprising iron and unavoidable impurities, wherein the unavoidable impurities comprise by weight:
$$C : 0.06 - 0.5 \% ,$$
$$Si : 0.05 - 0.6 \% ,$$
$$Mn : 0.4 - 3. \% ,$$
$$Al : 0.06 - 0.35 \% ,$$
$$B : 0.0005 - 0.01 \% ,$$
$$V : 0.01 - 0.5 \% ,$$
$$P : \leq 0.03 \% ,$$
$$S : \leq 0.02 \% ,$$
$$N : \leq 0.02 \% ,$$
$$Sn : \leq 0.03 \% ,$$
$$As : \leq 0.01 \% ,$$
and one or more of:
at least one element selected from “Ce, La, Nb, Cr, Cu, Mo, Ni, Ca, W” in following contents by weight:
$$Ce + La : 0.01 - 0.03 \% ,$$
$$Ti : 0.0005 - 0.1 \% ,$$
$$Nb : 0.001 - 0.2 \% ,$$
$$Cr : 0.01 - 1. \% ,$$
$$Cu : 0.01 - 0.2 \% ,$$
$$Mo : 0.002 - 0.3 \% ,$$
$$Ni : 0.01 - 0.5 \% ,$$
$$Ca : 0.0005 - 0.005 \% ,$$
$$W : 0.001 - 1. \% ,$$
at least one element selected from “C, Si, Mn, B, V, P, S, N, Sn, As, Ce+La” in following contents by weight:
$$C : 0.06 - 0.5 \% ,$$
$$Si : 0.05 - 0.6 \% ,$$
$$Mn : 0.4 - 3. \% ,$$
$$B : 0.0005 - 0.01 \% ,$$
$$V : 0.01 - 0.5 \% ,$$
$$P : \leq 0.03 \% ,$$
$$S : \leq 0.02 \% ,$$
$$N : \leq 0.02 \% ,$$
$$Sn : \leq 0.03 \% ,$$
$$As : \leq 0.01 \% ,$$
$$Ce + La : 0.01 - 0.03 \% ,$$
and
at least one element selected from “Al, Nb, Cr, Cu, Mo, Ni, Ca, W” in following contents by weight:
$$Al : \leq 1. \% ,$$
$$Ti : 0.0005 - 0.1 \% ,$$
$$Nb : 0.001 - 0.2 \% ,$$
$$Cr : 0.01 - 1. \% ,$$
$$Cu : 0.01 - 0.2 \% ,$$
$$Mo : 0.002 - 0.2 \% ,$$
$$Ni : 0.01 - 0.5 \% ,$$
$$Ca : 0.0005 - 0.005 \% ,$$
$$W : 0.001 - 1. \% .$$

22. The flat steel product of claim 21, wherein a ratio Al/(Nb+V) of Al content to a sum total of Nb and V contents is: Al/(Nb+V)≤30.0

23. The flat steel product of claim 21 meets following condition:
$$0.7 \% by weight < Mn + Cr < 3.5 \% by weight$$

24. The flat steel product of claim 21 comprising an anticorrosion coating on at least one side of the flat sheet product.

25. The flat steel product of claim 24, wherein the anticorrosion coating is an aluminum-based anticorrosion coating and has an alloy layer and an Al base layer.

26. The flat steel product of claim 25, wherein the alloy layer comprises 35-60% by weight of Fe and constituents limited to a total of not more than 5.0% by weight, and aluminum as the balance, and/or the Al base layer comprises 1.0-15% by weight of Si, and one or more of: 2-4% by weight of Fe, up to 5.0% by weight of alkali metals or alkaline earth metals, up to 10% Zn further constituents limited to not more than 2.0% by weight, and aluminum as the balance.

27. The flat steel product of claim 21 has a yield point with a continuous progression (Rp0.2) or a yield point having a difference (ΔRe) between an upper yield point limit (ReH) and a lower yield point limit (ReL) of not more than 50 MPa.

28. A shaped sheet metal part formed from the flat steel product of claim 21.

29. A shaped sheet metal part formed from the flat steel product of claim 24.

30. A shaped sheet metal part formed from the flat steel product of claim 22.

31. A shaped sheet metal part formed from the flat steel product of claim 21, wherein the steel substrate has a structure having more than 90% martensite and/or lower bainite at least in part.

32. A shaped sheet metal part formed from the flat steel product of claim 21 at least partly has one or more characteristics comprising:
a yield point of at least 950 MPa;
a tensile strength of at least 1000 MPa;
an elongation at break A50 of at least 4%; and
a bending angle of at least 30°.

33. A shaped sheet metal part formed from the flat steel product of claim 21 has fine precipitates in its structure in a form of vanadium carbonitrides, niobium carbonitrides and/or titanium carbonitrides.

34. A shaped sheet metal part formed from the flat steel product of claim 21 has a breaking stress in a modified slow strain rate test of greater than 610 MPa.

35. A process for producing a shaped sheet metal part formed from a flat steel product for hot forming with an anticorrosion coating, comprising following steps:
a) providing a steel slab comprising iron and unavoidable impurities, wherein the unavoidable impurities comprise by weight:
$$C : 0.06 - 0.5 \% ,$$
$$Si : 0.05 - 0.6 \% ,$$
$$Mn : 0.4 - 3. \% ,$$
$$Al : 0.06 - 0.35 \% ,$$
$$B : 0.0005 - 0.01 \% ,$$
$$V : 0.01 - 0.5 \% ,$$
$$P : \leq 0.03 \% ,$$
$$S : \leq 0.02 \% ,$$
$$N : \leq 0.02 \% ,$$
$$Sn : \leq 0.03 \% ,$$
$$As : \leq 0.01 \% ,$$
and one or more of:
at least one element selected from “Ce, La, Nb, Cr, Cu, Mo, Ni, Ca, W” in following contents by weight:
$$Ce + La : 0.01 - 0.03 \% ,$$
$$Ti : 0.0005 - 0.1 \% ,$$
$$Nb : 0.001 - 0.2 \% ,$$
$$Cr : 0.01 - 1. \% ,$$
$$Cu : 0.01 - 0.2 \% ,$$
$$Mo : 0.002 - 0.2 \% ,$$
$$Ni : 0.01 - 0.5 \% ,$$
$$Ca : 0.0005 - 0.005 \% ,$$
$$W : 0.001 - 1. \% ,$$
at least one element selected from “C, Si, Mn, B, V, P, S, N, Sn, As, Ce+La” in following contents by weight:
$$C : 0.06 - 0.5 \% ,$$
$$Si : 0.05 - 0.6 \% ,$$
$$Mn : 0.4 - 3. \% ,$$
$$B : 0.0005 - 0.01 \% ,$$
$$V : 0.01 - 0.5 \% ,$$
$$P : \leq 0.03 \% ,$$
$$S : \leq 0.02 \% ,$$
$$N : \leq 0.02 \% ,$$
$$Sn : \leq 0.03 \% ,$$
$$As : \leq 0.01 \% ,$$
$$Ce + La : 0.01 - 0.03 \% ,$$
and
at least one element selected from “Al, Nb, Cr, Cu, Mo, Ni, Ca, W” in following contents by weight:
$$Al : \leq 1. \% ,$$
$$Ti : 0.0005 - 0.1 \% ,$$
$$Nb : 0.001 - 0.2 \% ,$$
$$Cr : 0.01 - 1. \% ,$$
$$Cu : 0.01 - 0.2 \% ,$$
$$Mo : 0.002 - 0.2 \% ,$$
$$Ni : 0.01 - 0.5 \% ,$$
$$Ca : 0.0005 - 0.005 \% ,$$
$$W : 0.001 - 1. \% ;$$
b) through-heating the steel slab at a temperature (T1) of 1100-1400° C.;
c) optionally pre-rolling the through-heated steel slab to give an intermediate product having an intermediate product temperature (T2) of 1000-1200° C.;
d) hot rolling to give a hot-rolled flat steel product, where a final rolling temperature (T3) is 750-1000° C.;
e) optionally coiling the hot-rolled flat steel product, where a coiling temperature (T4) is not more than 700° C.;
f) descaling the hot-rolled flat steel product;
g) optionally cold-rolling the flat steel product, where a degree of cold rolling is at least 30%;
h) annealing the flat steel product at an annealing temperature (T5) of 650-900° C.;
i) cooling the flat steel product to an immersion temperature (T6) of 650-800° C.;
j) coating the flat steel product having an anticorrosion coating that has been cooled to the immersion temperature by hot dip coating in a melt bath having a melt temperature (T7) of 660-800° C.;
k) cooling the coated flat steel product to room temperature, where a first cooling period t_{MT} in a temperature range between 600° C. and 450° C. is more than 5 s, and a second cooling period t_{LT} in a temperature range between 400° C. and 300° C. is more than 4 s;
l) optionally skin pass rolling the coated flat steel product.

36. The process of claim 35, wherein a ratio Al/(Nb+V) of Al content to a sum total of Nb and V contents of the steel slab is: Al/(Nb+V)≤30.0.

37. The process of claim 35, wherein in the hot dip coating of step j), a melt bath is used that contains a anticorrosive to be applied to the flat steel product in liquid form, wherein the anticorrosive comprises one or more of: 0.1% to 15% by weight of Si, 2-4% by weight of Fe, up to 5% by weight of alkali metals or alkaline earth metals, up to 10% Zn, further constituents of not more than 2.0% by weight, and aluminum as the balance.

38. The process of claim 35, wherein the steps further comprise steps:
m) providing a sheet metal blank composed of the flat steel product of claim 21;
n) heating the sheet metal blank such that an AC3 temperature of the sheet metal blank is exceeded at least to some degree and a temperature Tᵢₙₛ of the sheet metal blank on insertion into a forming tool provided for a hot press forming operation (step c)) is at least partly at a temperature above Ms+100° C., where Ms denotes a martensite start temperature;
o) inserting the heated sheet metal blank into a forming tool, where a transfer time tₜᵣₐₙₛ required for the removal from the heating device and the insertion of the sheet metal blank is not more than 20 s;
p) hot press forming the sheet metal blank to give the shaped sheet metal part, where the sheet metal blank in the course of hot press forming is cooled to the target temperature T_{target} over a period tₜₒₒₗ of more than 1 s at a cooling rate rₜₒₒₗ of at least partly more than 30 K/s and optionally held at that temperature;
q) removing the shaped sheet metal part that has been cooled to the target temperature T_{target} from the tool.

39. The process of claim 35, wherein the temperature attained in step b) at least to some degree in the sheet metal blank is between the Ac3 temperature and 1000° C., or between 850° C. and 950° C.

40. The process of claim 35, wherein the target temperature T_{target} of the shaped sheet metal part is at least to some degree below 400° C.
